(19) United States
(12) Patent Application Publication
(10) Pub. No.: US 2026/0296569 A1
(43) Pub. Date: Oct. 1, 2026

(54) CONTROL OF SPLIT-DOOR TAILGATE ASSEMBLY

(71) Applicant: Aisin Corporation, Kariya-Shi (JP)

(72) Inventors: Shad Issa, Garden City, MI (US); Joseph Bolewitz, Novi, MI (US); Matthew Clary, Royal Oak, MI (US); Jeremy Crider, Canton, MI (US)

(21) Appl. No.: 19/096,216

(22) Filed: Mar. 31, 2025

(51) Int. Cl. B62D 33/03; B62D 33/037; E05F 15/40

(52) U.S. Cl. CPC B62D 33/03; B62D 33/037; E05F 15/40; E05Y 2400/354

(57) ABSTRACT

Systems, methods, and other embodiments described herein relate to the control of a powered split-door tailgate assembly. In one embodiment, a method includes sequentially pivoting a first tailgate door and a second tailgate door of a split-door tailgate assembly about respective vertical axes responsive to a first input. The method also includes pivoting the first tailgate door about a first vertical axis responsive to a second input. The method also includes disengaging frame latches to facilitate a pivot of the first tailgate door and the second tailgate door about a horizontal axis responsive to a third input. The method further includes pivoting the second tailgate door about a second vertical axis responsive to a fourth input.

### TECHNICAL FIELD

The subject matter described herein relates, in general, to split-door vehicle tailgates and, more particularly, to a controller that articulates the tailgate doors in a coordinated fashion.

### BACKGROUND

Trucks, which are a type of vehicle, include an open cargo space behind the cabin of the truck. This open cargo space may be referred to as a bed and is defined by sidewalls and a front wall. The front wall may be immediately behind the truck cabin. Both the sidewalls and the front wall rise from a surface that may be referred to as a bed floor.

A tailgate may form the fourth wall of the box-shaped cargo bed. In general, the tailgate pivots upward and downward about a horizontal axis at the base of the tailgate. Specifically, when in a closed or raised position, the contents of the cargo bed may be prevented from sliding out of the bed while the vehicle is moving. The tailgate may be dropped to access the cargo or when loading new cargo into the bed. Thus, the cargo bed resembles a box-like structure, with one box wall pivotable about a horizontal axis. As such, truck beds provide an area to store large cargo or large quantities of cargo, all while providing easy access to load or unload said cargo.

### SUMMARY

In one embodiment, example systems and methods relate to a manner of improving vehicle tailgate operation.

In one embodiment, a tailgate control system for articulating tailgate doors is disclosed. The tailgate control system includes a processor and a memory storing machine-readable instructions. The machine-readable instructions, when executed by the processor, cause the processor to sequentially pivot a first tailgate door and a second tailgate door of a split-door tailgate assembly about respective vertical axes responsive to a first input. The machine-readable instructions, when executed by the processor, cause the processor to pivot the first tailgate door about a first vertical axis responsive to a second input. The machine-readable instructions, when executed by the processor, cause the processor to disengage frame latches to facilitate a pivot of the first tailgate door and the second tailgate door about a horizontal axis responsive to a third input. The machine-readable instructions, when executed by the processor, also cause the processor to pivot the second tailgate door about a second vertical axis responsive to a fourth input.

In one embodiment, a non-transitory machine-readable medium for articulating tailgate doors is disclosed. The non-transitory machine-readable medium includes instructions that, when executed by a processor, cause the processor to perform one or more functions as disclosed. The instructions include instructions to sequentially pivot a first tailgate door and a second tailgate door of a split-door tailgate assembly about respective vertical axes responsive to a first input. The instructions include instructions to pivot the first tailgate door about a first vertical axis responsive to a second input. The instructions include instructions to disengage frame latches to facilitate a pivot of the first tailgate door and the second tailgate door about a horizontal axis responsive to a third input. The instructions include instructions to pivot the second tailgate door about a second vertical axis responsive to a fourth input.

In one embodiment, a method for articulating tailgate doors is disclosed. In one embodiment, the method includes sequentially pivoting a first tailgate door and a second tailgate door of a split-door tailgate assembly about respective vertical axes responsive to a first input. The method also includes pivoting the first tailgate door about a first vertical axis responsive to a second input. The method also includes disengaging frame latches to facilitate a pivot of the first tailgate door and the second tailgate door about a horizontal axis responsive to a third input. The method also includes pivoting the second tailgate door about a second vertical axis responsive to a fourth input.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a split-door tailgate assembly managed by a tailgate control system.

FIGS. 2A – 2D illustrate one embodiment of input switches and a control scheme for a tailgate control system.

FIG. 3 illustrates one embodiment of a tailgate control system that is associated with articulating tailgate doors.

FIG. 4 illustrates a flowchart for one embodiment of a method that is associated with articulating tailgate doors.

FIGS. 5A and 5B illustrate flowcharts of one embodiment for articulating tailgate doors based on inputs from a first switch.

FIG. 6 illustrates a flowchart of one embodiment for articulating tailgate doors based on inputs from a second switch.

FIG. 7 illustrates a flowchart of one embodiment for articulating tailgate doors based on inputs from a third switch.

### DETAILED DESCRIPTION

Systems, methods, and other embodiments associated with improving vehicle tailgate control are disclosed herein. As previously described, trucks include an open cargo space behind the cabin of the truck. This open cargo space may be referred to as a bed and is defined by sidewalls and a front wall. A pivotable tailgate forms the fourth wall of the box-shaped cargo bed. In general, the tailgate pivots upward and downward about a horizontal axis at the base of the tailgate. When raised, the tailgate prevents the cargo from being dislodged from the cargo bed. To access the cargo bed (e.g., to load or unload cargo), the tailgate may be pivoted about a horizontal axis to an opened or lowered position. As such, truck beds provide an area to store large cargo or large quantities of cargo while providing easy access to load or unload said cargo.

While tailgates undoubtedly provide great utility due to their increased carrying capacity and ability to provide quick and easy access to the contents of the truck bed (i.e., a pivotable tailgate), additional developments may enhance their ease of use and utility. For example, a lowered tailgate increases the distance between the user and the cargo in the bed. This may make certain cargo, especially cargo further back in the cargo bed, difficult to reach. Moreover, a lowered tailgate may eliminate the ability of a user to use a vehicle bumper as a step to get into or out of the cargo bed.

Accordingly, the present specification describes a split-door tailgate assembly. That is, the tailgate assembly may include two tailgate doors, each of which pivots about a vertical axis on either side of the truck bed opening. A combined width of the tailgate doors spans the width of the opening. The tailgate doors may swing open about the respective vertical axes. When desired, the tailgate doors can be locked together, allowing the split-door tailgate to be lowered about the horizontal axis.

However, even split tailgate doors may be heavy and cumbersome to manipulate. Moreover, it may be that a user is carrying an object and, therefore, cannot manually open the tailgate doors without dropping the object. In either of these cases, it may be difficult and inconvenient for a user to manually articulate the split tailgate doors. Moreover, the manual activation of the tailgate doors may limit a user to operating the tailgate and providing access to the cargo when near the vehicle.

The present specification describes a split-door tailgate assembly where the tailgate doors can swing outward about a vertical axis and simultaneously swing downward about a horizontal axis. The outward movement about the vertical axis is driven by a powered hinge, allowing a user to avoid manually opening the tailgate doors.

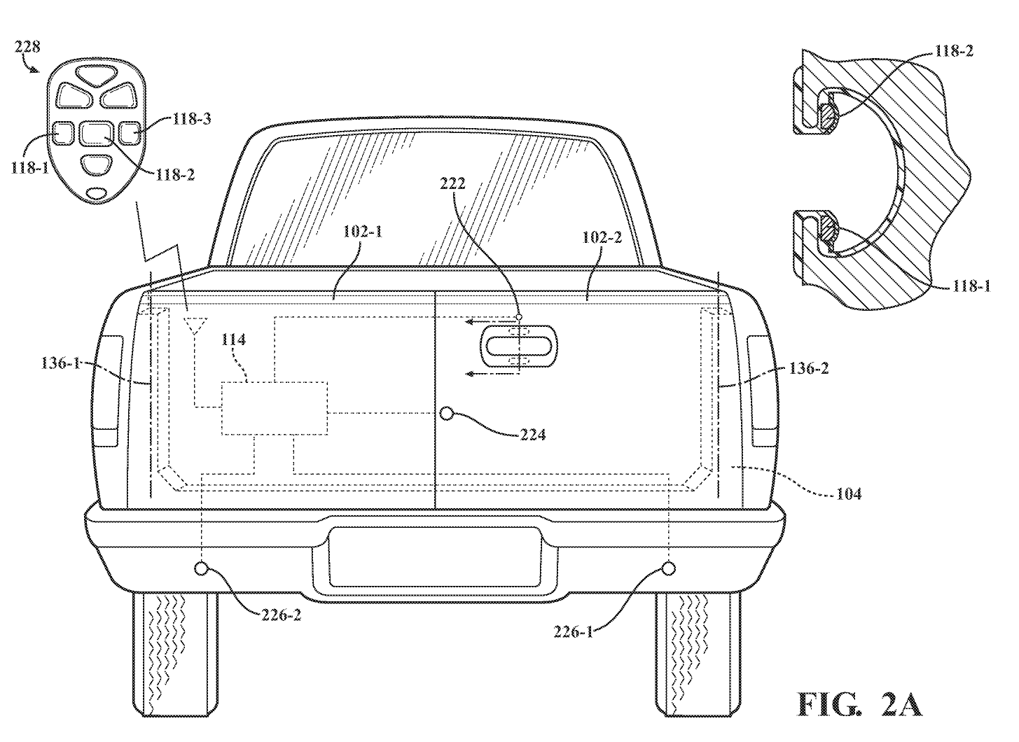

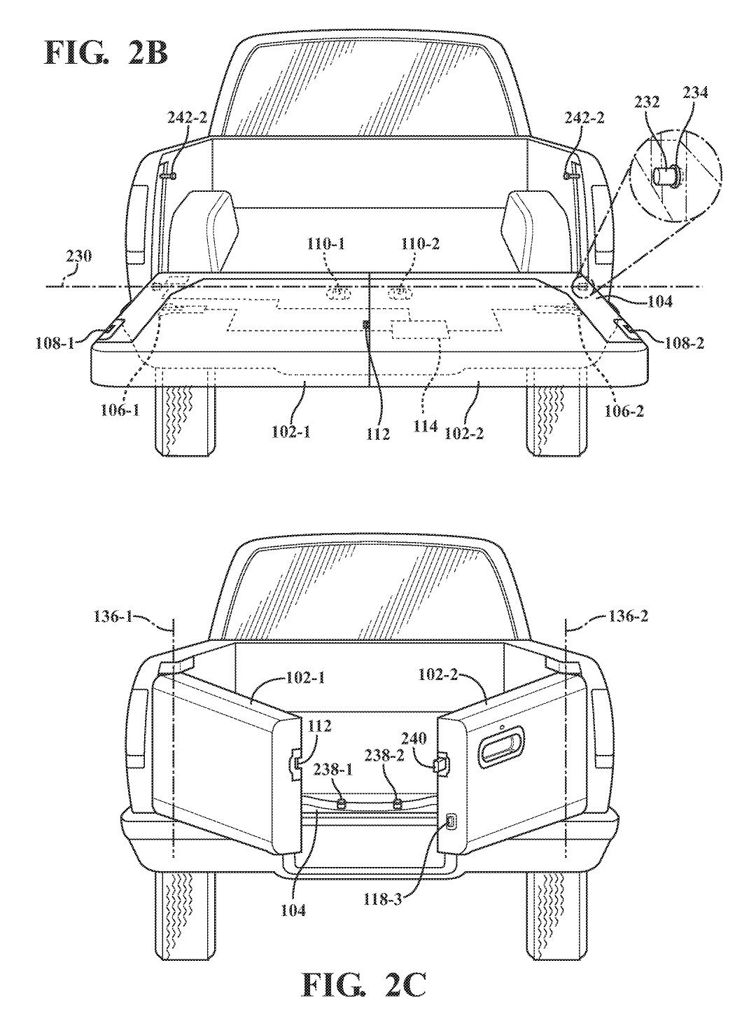

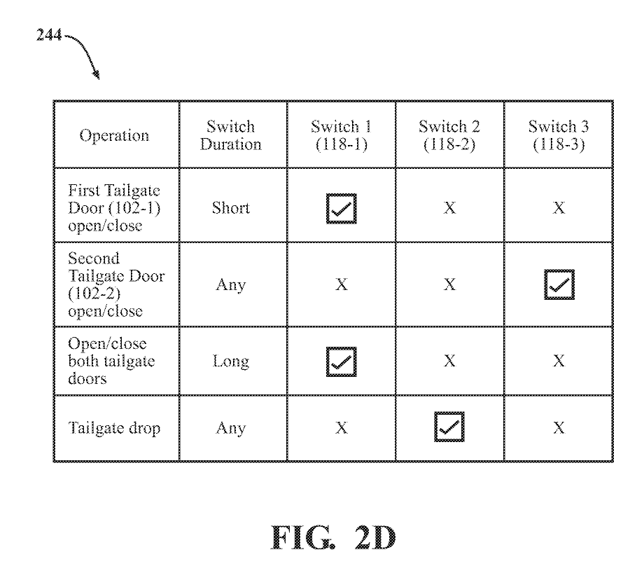

The tailgate assembly features a tailgate control system that coordinates the safe and effective articulation (opening and closing) of the various tailgate doors. That is, a split-door tailgate assembly may have physical constraints that preclude the operation of the doors in a certain fashion. For example, the tailgate doors may have a sequence in which they can be opened and closed. As a specific example, due to the arrangement of latches that hold the tailgate doors closed, as depicted in FIG. 2C, it may be the case that a second tailgate door is closed before a first tailgate door. In this example, the second tailgate door or a powered hinge of the second tailgate door may become damaged if the second tailgate door is closed after the first tailgate door. That is, the second tailgate door, or a latch thereon, may slam into the first tailgate door.

As another example, while a user is swinging the tailgate assembly downwards about a horizontal axis, as depicted in FIG. 2B, if the tailgate doors are not held rigidly in place, the split tailgate doors may swing away from each other. This could damage the tailgate assembly or other vehicle parts or injure the operator.

Accordingly, the split-door tailgate assembly includes a frame member that is disposed around the edges of the tailgate doors, between the tailgate doors and the frame of the vehicle. Specifically, a first vertical portion of the frame member is disposed between a first sidewall of the truck bed and an outside edge of a first tailgate door. A second vertical portion of the frame member is disposed between a second sidewall of the truck bed and an outside edge of a second tailgate door. A horizontal portion of the frame member joins the bases of the respective vertical portions and sits between the floor of the truck bed and the bottom edges of both tailgate doors. In this example, the frame member is a U-shaped structure.

The frame member pivots about a horizontal axis relative to the vehicle frame. The frame member, and the attached tailgate doors, are selectively prevented from pivoting about the horizontal axis via frame latches. Each tailgate door is attached to the frame member via a hinge and can pivot about a respective vertical axis. The tailgate doors are selectively prevented from pivoting about the vertical axes via respective door latches.

A powered hinge controls the movement of a respective tailgate door. The powered hinges are disposed within respective tailgate doors. One end of a check arm of the powered hinge is pivotally connected to the frame member. A powered hinge operates to extend a check arm from the powered hinge. Extension of the check arm presses against the frame member. Given that the frame member is in a fixed location, an extension of the check arm articulates the respective tailgate door, which is moveable, about a vertical axis. In an example, the powered hinge and check arm may be structured to articulate the tailgate door through at least 85 degrees of rotational motion and, in some cases, through more than 90 degrees of rotational motion. As described in more detail below, the tailgate assembly comprises additional components that enable the dual motion (i.e., swinging outward about a vertical axis and swinging downward about a horizontal axis) of the tailgate door(s).

As described above, the tailgate control system may receive user input associated with target states of the split-door tailgate assembly and may articulate the tailgate doors toward the target state. In an example, the user input is received via switches (such as mechanical switches, electromechanical switches, and/or capacitive switches) on the tailgate doors themselves or from a remote controller, as may be found in a key fob.

In an example, the tailgate control system receives input from three switches; however, the different inputs described herein could be received from any number of switches. Returning to a three-switch example, a first switch may be activated in two ways, for example, by a long pulse and a short pulse. Responsive to activation of the first switch with a long pulse, the tailgate control system may sequentially articulate (open or close) both the first tailgate door and the second tailgate door about respective vertical axes. Responsive to activation of the first switch with a short pulse, the tailgate control system may articulate (open or close) just the first tailgate door. Responsive to the activation of a second switch, the tailgate control system may facilitate the articulation of both tailgate doors about a horizontal axis. That is to say, the tailgate control system may engage an inter-door latch, preventing the tailgate doors from swinging away from each other as they are rotated about the horizontal axis. Responsive to the activation of a third switch, the tailgate control system may articulate (open or close) just the second tailgate door.

In this manner, the disclosed vehicle tailgate assemblies enable hands-free automatic articulation of the vehicle tailgate doors about one axis (i.e., a vertical axis) and joint articulation about a second axis (i.e., a horizontal axis). These movements are executed in a manner that ensures the safety of the operator and ensures the operation of the tailgate doors without damaging the doors or other components of the split-door tailgate assembly or the vehicle. The multiple opening modalities enable versatile loading and unloading scenarios due to the independent control of the tailgate doors. Moreover, such operations may be triggered from a key fob, so the user does not need to be near the vehicle to operate the tailgate.

As used in the present specification and in the appended claims, the term “open state” may refer to the state of a tailgate door, or the coupled tailgate doors, where the door(s) do not form a vertical wall of the cargo bed. By comparison, the term “closed state” may refer to the state where a tailgate door, or the coupled tailgate doors, form a vertical wall of the cargo bed. For example, coupled tailgate doors in a horizontal orientation may be in an “open state,” while coupled tailgate doors in a vertical orientation may be in a “closed state.” Similarly, a single tailgate door that is in a vertical orientation and perpendicular to a sidewall of the truck bed may be in a “closed state,” while a tailgate door that is at a non-perpendicular angle relative to a truck bed sidewall may be in an “open state.” As described below, the state of the door may be determined in various ways, such as based on the state of various latches and/or based on the indication of door position.

Moreover, as used in the present specification and in the appended claims, the term “short pulse” may refer to an actuation of a switch that is less than a threshold duration, while a “long pulse” may refer to an actuation of a switch that is greater than the threshold duration. The threshold duration may be any amount of time and may be selected by a manufacturer. In an example, the threshold may be one or two seconds. Accordingly, depression of a mechanical button for less than one second may be defined as a “short pulse,” while depression of the mechanical button for greater than one second may be defined as a “long pulse.”

In this description, uses of “front,” “forward,” and the like, and uses of “rear,” “rearward,” and the like, refer to the longitudinal directions of the vehicle. “Front,” “forward,” and the like refer to the front (fore) of the vehicle, while “rear,” “rearward,” and the like refer to the back (aft) of the vehicle. Uses of “side,” “sideways,” “transverse,” and the like refer to the lateral directions of the vehicle. Uses of “above,” “below,” and the like refer to the vertical directions of the vehicle.

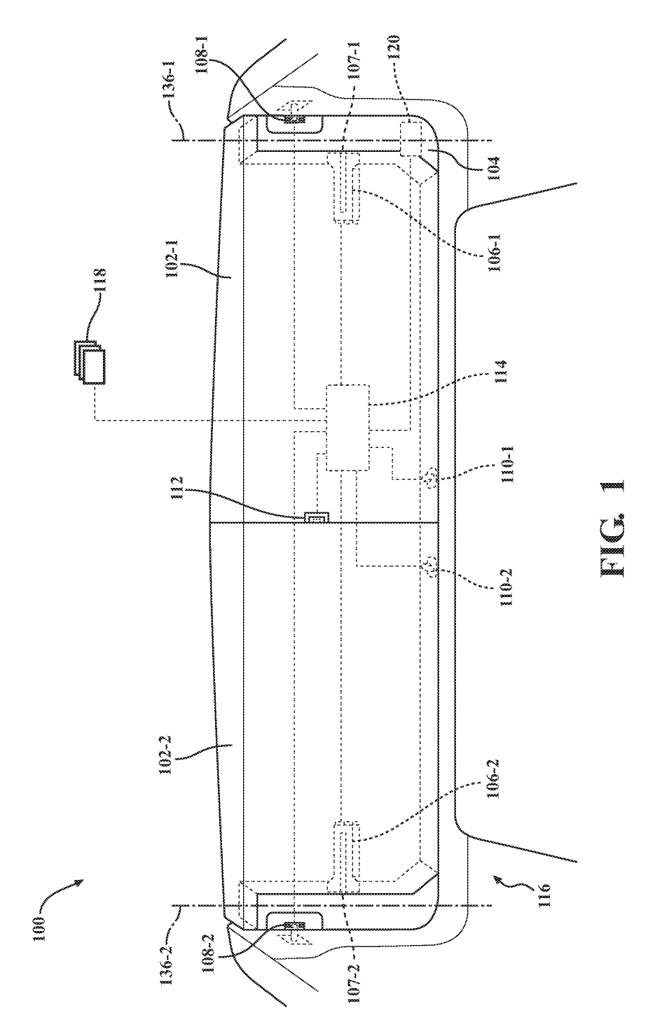

Turning now to the figures, FIG. 1 illustrates one embodiment of a split-door tailgate assembly 100 with two tailgate doors 102-1 and 102-2 in a closed position, driven by powered hinges 106-1 and 106-2. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

Returning to the figures, the split-door tailgate assembly 100 includes a first tailgate door 102-1 that extends across a first portion of the width of the opening of the truck bed 116. The split-door tailgate assembly 100 also includes a second tailgate door 102-2. A combined width of the first tailgate door 102-1 and the second tailgate door 102-2 spans the width of the opening of the truck bed 116.

As depicted in FIG. 2C, the tailgate doors 102-1 and 102-2 may pivot about respective vertical axes 136-1 and 136-2. However, the tailgate doors 102-1 and 102-2, rather than being hingedly connected to the frame of the vehicle, may be hingedly attached to a frame member 104. In general, the frame member 104 is a rigid component that sits between the tailgate doors 102-1 and 102-2 and the frame of the vehicle. The frame member 104 may include a 1) horizontal portion that is below the tailgate doors 102-1 and 102-2 and between the tailgate doors 102-1 and 102-2 and a bed of the frame of the vehicle and 2) vertical portions that are to the side of each respective tailgate door 102-1 and 102-2 and between the respective tailgate door 102-1 and 102-2 and an adjacent vertical sidewall of the truck bed 116. That is, the frame member 104 may be U-shaped.

The portions of the frame member 104 that are to the side of the tailgate doors 102-1 and 102-2 (i.e., the vertical portions of the frame member 104) may include frame latches 108-1 and 108-2 that interact with pins on the vehicle frame to prevent the frame member 104 and tailgate doors 102-1 and 102-2 from pivoting about the horizontal axis. That is, the frame member 104 may selectively pivot about a horizontal axis, as depicted in FIG. 2B. In one particular example, the frame member 104 may include a protrusion or recess along a bottom edge that interacts with a corresponding recess or protrusion on the vehicle frame. The longitudinal axis of the protrusion/recess defines the horizontal axis about which the frame member 104 rotates.

During some uses, for example, when the tailgate doors 102-1 and 102-2 are to be swung out about vertical axes 136-1 and 136-2, as depicted in FIG. 2C, the frame member 104 may be affixed to the vehicle frame via the respective frame latches 108-1 and 108-2. That is, the split-door tailgate assembly 100 may include a first frame latch 108-1 and a second frame latch 108-2 to selectively prevent the frame member 104 from rotating relative to the frame of the vehicle.

The frame latches 108-1 and 108-2 may take various forms. For example, as depicted in FIG. 2B, posts may extend inward from either sidewall of the truck bed 116. The frame latches 108-1 and 108-2 may be structured to selectively release from these posts. For example, the frame latches 108-1 and 108-2 may include a hooked latch. When engaged, the hooked latches wrap around at least a portion of the respective post, preventing the frame member 104 from pivoting about a horizontal axis. Upon activating an actuator (i.e., activation of a switch 118), the hooked latches rotate and are released from the respective post such that the frame member 104, and mounted tailgate doors 102-1 and 102-2, may rotate downward about the horizontal axis. That is, when engaged, the frame latches 108-1 and 108-2 prevent the frame member 104 from rotating about the horizontal axis, and when disengaged, the frame latches 108-1 and 108-2 allow the frame member 104 to rotate about the horizontal axis. FIG. 2C depicts frame latches 108-1 and 108-2 engaged with the vehicle frame pins and FIG. 2B depicts frame latches 108-1 and 108-2 disengaged from the vehicle frame pins. While particular reference is made to hooked latches, the frame latches 108-1 and 108-2 may be of a variety of types including non-hook latches that include bolts, springs, magnets, cams, or combinations thereof that may selectively prevent the rotation of the frame member 104, and mounted tailgate doors 102-1 and 102-2, about the horizontal axis.

In one example, the frame latches 108-1 and 108-2 are electromechanical latches that are activated by the tailgate control system 114 based on input received from at least one switch 118. In an example, the frame latches 108-1 and 108-2 may be automatic door closers. That is, the frame latches 108-1 and 108-2 may have the capacity to pull the frame member 104, and the mounted tailgate doors 102-1 and 102-2, from a nearly closed position to a fully closed position. In this example, sensors on the frame member 104 and/or the vehicle frame may detect that the frame member 104 is in a nearly closed position. As a specific example, the sensors may determine that the frame member 104 is within a specific range (e.g., 5-10% or 5-10 degrees) of a fully closed position. In this example, the frame latches 108-1 and 108-2 may include a small electric motor that pulls the frame member 104 into a fully seated position and activates the hooked latch, retaining the frame member 104 in place.

The portion of the frame member 104 that is below the tailgate doors 102-1 and 102-2 (i.e., the horizontal portion of the frame member 104) may include strike plates that interact with the door latches 110-1 and 110-2 on the respective tailgate doors 102-1 and 102-2 to prevent the tailgate doors 102-1 and 102-2 from pivoting about the vertical axis. That is, each tailgate door 102-1 and 102-2 may selectively pivot about a respective vertical axis 136-1 and 136-2 as depicted in FIG. 2C, with the first tailgate door 102-1 pivoting about a first vertical axis 136-1 and the second tailgate door 102-2 pivoting about a second vertical axis 136-2. That is, the vertical portions of the frame member 104 may include hinges that allow the respective tailgate doors 102-1 and 102-2 to rotate about their respective vertical axes 136-1 and 136-2.

During some uses, for example, when the tailgate doors 102-1 and 102-2 are to be swung downward about a horizontal axis as depicted in FIG. 2B, the tailgate doors 102-1 and 102-2 may be affixed to the frame member 104 via respective door latches 110-1 and 110-2. That is, the split-door tailgate assembly 100 may include a first door latch 110-1 and a second door latch 110-2 to selectively prevent the first tailgate door 102-1 and the second tailgate door 102-2, respectively, from rotating relative to the frame member 104. Moreover, when the tailgate doors 102-1 and 102-2 are to be swung downward about a horizontal axis, as depicted in FIG. 2B, the tailgate doors 102-1 and 102-2 may be affixed to one another via the inter-door latch 112. Doing so prevents either tailgate door 102-1 and 102-2 from swinging about the respective vertical axes 136-1 and 136-2 as the split-door tailgate assembly 100 is swung down about the horizontal axis, which could injure a nearby individual and/or damage the vehicle and split-door tailgate assembly 100.

The door latches 110-1 and 110-2 may take various forms. For example, as depicted in FIG. 2C, the frame member 104 may include posts extending upward from a horizontal portion of the frame member 104. The door latches 110-1 and 110-2 may be structured to selectively release from these posts. For example, the door latches 110-1 and 110-2 may include hooked latches. When engaged, the hooked latches wrap around at least a portion of the respective post and prevent the respective tailgate doors 102-1 and 102-2 from rotating about respective vertical axes. Upon activating an actuator (i.e., activation of a switch 118), the hooked latches rotate and are released from the respective posts such that the respective tailgate doors 102-1 and 102-2 may rotate outward about respective vertical axes. That is, when engaged, the door latches 110-1 and 110-2 prevent the respective tailgate doors 102-1 and 102-2 from rotating about respective vertical axes, and when disengaged, the door latches 110-1 and 110-2 allow the respective tailgate doors 102-1 and 102-2 to rotate about respective vertical axes. FIG. 2C depicts door latches 110-1 and 110-2 disengaged with the frame member posts, and FIG. 2B depicts door latches 110-1 and 110-2 engaged with frame member posts.

While particular reference is made to hooked latches, the door latches 110-1 and 110-2 may be of a variety of types including non-hook latches that include bolts, springs, magnets, cams, or combinations thereof that may selectively prevent the rotation of the the tailgate doors 102-1 and 102-2 about respective vertical axes 136-1 and 136-2.

In one example, the door latches 110-1 and 110-2 are electromechanical latches that are activated by the tailgate control system 114 based on input received from at least one switch 118. In an example, the door latches 110-1 and 110-2 may be automatic door closers. That is, the door latches 110-1 and 110-2 may be able to pull the respective tailgate doors 102-1 and 102-2 from a nearly closed position to a fully closed one. In this example, sensors on the tailgate doors 102-1 and 102-2, and/or the frame member 104, may determine that the respective tailgate doors 102-1 and 102-2 are nearly closed. As a specific example, the sensors may determine that the respective tailgate door 102-1 and 102-2 is within a specific range (e.g., 5-10% or 5-10 degrees) of a fully closed position. In this example, the door latches 110-1 and 110-2 may include a small electric motor that pulls the respective tailgate door 102-1 and 102-2 to a fully seated position and activates the latch (e.g., hook) that retains the respective tailgate door 102-1 and 102-2 in place. This system of latches (i.e., door frame latches 108-1 and 108-2, door latches 110-1 and 110-2, and the inter-door latch 112) facilitates the dual-axis motion of the tailgate doors 102-1 and 102-2.

As described above, the tailgate doors 102-1 and 102-2 may be heavy and cumbersome to swing open about the vertical axes 136-1 and 136-2. Moreover, a user’s hands/arms may not be free to physically manipulate the tailgate doors 102-1 and 102-2 as may occur, for example, when carrying cargo to load into the truck bed 116. Accordingly, in this example, the split-door tailgate assembly 100 includes a powered hinge 106-1 and 106-2 per tailgate door 102-1 and 102-2, respectively, to articulate the respective tailgate doors 102-1 and 102-2 about their respective vertical axes 136-1 and 136-2. Specifically, in the example depicted in FIG. 1, the split-door tailgate assembly 100 includes 1) a first powered hinge 106-1 that articulates the first tailgate door 102-1 about a first vertical axis 136-1 and 2) a second powered hinge 106-2 that articulates the second tailgate door 102-2 about a second vertical axis 136-2.

In general, the powered hinges 106-1 and 106-2 include a motor assembly within a housing. The motor assembly operates to extend a respective check arm 107-1 and 107-2 from the housing. In general, the motor assembly converts electrical energy, supplied by the vehicle in some examples, into mechanical energy (i.e., rotation of a threaded spindle).

The powered hinges 106-1 and 106-2 also include a drive assembly that converts the rotational motion of the motor into a translational movement of the respective check arms 107-1 and 107-2. The drive assembly may include a threaded spindle rotated by the motor assembly. The drive assembly also includes a threaded nut that surrounds and is coaxial to the threaded spindle. Due to the interface of these threads, the threaded nut translates along the threaded spindle as the threaded spindle rotates. The direction of translation depends on the direction of rotation of the threaded spindle. For example, as the threaded spindle rotates in one direction (e.g., clockwise), the threaded nut may translate in a first direction. This movement may cause the check arms 107-1 and 107-2, which are coupled to the threaded nut, to also translate in the first direction. This may cause the check arms 107-1 and 107-2 to press against the frame member 104, causing the respective tailgate doors 102-1 and 102-2 to swing open about their respective vertical axes 136-1 and 136-2.

By comparison, as the threaded spindle rotates in the opposite direction, the threaded nut may translate in a direction opposite the first. This movement may cause the check arms 107-1 and 107-2, which are coupled to the threaded nuts, to also translate in a direction opposite to the first direction. This may cause the check arms 107-1 and 107-2 to pull against the frame member 104, causing the respective tailgate doors 102-1 and 102-2 to swing closed about the respective vertical axes 136-1 and 136-2.

An end of the check arm 107-1 and 107-2 that is within the housing is rigidly mounted within a respective tailgate door 102-1 and 102-2 (which is movable when the associated door latch 110-1 and 110-2 is disengaged) and the other end is pivotally coupled to the frame member 104 (which is immovable when the frame latches 108-1 and 108-2 are engaged). Specifically, the first powered hinge 106-1 is mounted within (i.e., between an outside environment-facing surface and an inside bed-facing surface) the first tailgate door 102-1 and is pivotally connected to the frame member 104. The first powered hinge 106-1 articulates the first tailgate door 102-1 about a first vertical axis 136-1. Similarly, the second powered hinge 106-2 is mounted within the second tailgate door 102-2 and is pivotally connected to the frame member 104. The second powered hinge 106-2 articulates the second tailgate door 102-2 about a second vertical axis 136-2.

In both cases, as the check arms 107-1 and 107-2 extend, they press against the frame member 104. However, given that 1) the frame member 104 is immovable in the direction of force of the check arm 107-1 and 107-2 against the frame member 104 and 2) the tailgate doors 102-1 and 102-2 are free to rotate, this force causes the tailgate doors 102-1 and 102-2 to rotate outwards about the respective vertical axes 136-1 and 136-2.

In an example, the split tailgate doors 102-1 and 102-2 may be coupled together. For example, it may be desirable to lower both tailgate doors 102-1 and 102-2 about the horizontal axis as depicted in FIG. 2B. To facilitate this coordinated movement, the first tailgate door 102-1 may include an inter-door latch 112 that selectively couples the first tailgate door 102-1 and the second tailgate door 102-2 together.

The inter-door latch 112 may take various forms. For example, as depicted in FIG. 2C, the second tailgate door 102-2 may include a post extending inward from a first door-facing sidewall. The inter-door latch 112 on the first tailgate door 102-1 may be structured to selectively release from this post. For example, the inter-door latch 112 may include a hooked latch. When engaged, the hooked latch wraps around at least a portion of the respective post, preventing the independent movement of the first tailgate door 102-1 and the second tailgate door 102-2. Upon activating an actuator (i.e., activation of a switch 118), the hooked latch rotates and is released from the respective post such that the respective tailgate doors 102-1 and 102-2 may independently rotate. That is, when engaged, the inter-door latch 112 prevents the tailgate doors 102-1 and 102-2 from rotating about respective vertical axes and couples the tailgate doors 102-1 and 102-2 to move together. When disengaged, the inter-door latch 112 allows the tailgate doors 102-1 and 102-2 to rotate about their respective vertical axes. FIG. 2C depicts a disengaged inter-door latch 112, and FIG. 2B depicts an engaged inter-door latch 112. While a particular reference is made to a hooked latch, the inter-door latch 112 may be of various types, including non-hook latches that utilize bolts, springs, magnets, cams, or combinations thereof, which selectively couple the tailgate doors 102-1 and 102-2 together.

In one example, the inter-door latch 112 is an electromechanical latch that is activated by the tailgate control system 114 based on input received from at least one switch 118. In an example, the inter-door latch 112 may be an automatic door closer. That is, the inter-door latch 112 may be able to pull the first tailgated door 102-1 from a nearly closed position to a fully closed one. In this example, sensors on the first tailgate door 102-1 and/or the second tailgate door 102-2 may determine that the first tailgate door 102-1 is in a nearly-closed position. As a specific example, the sensors may determine that the first tailgate door 102-1 is within a specific range (e.g., 5-10% or 5-10 degrees) of a fully closed position. In this example, the inter-door latch 112 may include a small electric motor that pulls the first tailgate door 102-1 to a fully seated position and activates the latch (e.g., hook) that retains the first tailgate door 102-1 in place.

In an example, the rotation about the coupled first tailgate door 102-1 and the second tailgate door 102-2 about the horizontal axis (i.e., a tailgate drop) may be facilitated by a powered tailgate hinge 120. Specifically, the powered tailgate hinge 120 may have two connection points, one to the frame member 104 and another to the frame of the vehicle. When activated, the powered tailgate hinge 120 may lower or raise the frame member 104, and mounted tailgate doors 102-1 and 102-2, about the horizontal axis. In a specific example, the powered tailgate hinge 120 may include a motor and spindle where the motor causes the spindle to rotate. The spindle is coupled to the frame member 104 and therefore causes the frame member 104, and mounted tailgate doors 102-1 and 102-2, to rotate about a horizontal axis. While particular reference is made to a particular operational modality, the powered tailgate hinge 120 may include other components or other arrangements of components to facilitate the raising and lowering of the split-door tailgate assembly 100 about the horizontal axis. In another example, the articulation about the horizontal axis may be manual, in that an operator, sometimes relying on supporting structures such as hydraulic pistons, may lift and lower the frame member 104 and tailgate doors 102-1 and 102-2.

Activation of the powered hinges 106-1 and 106-2, and the movement of the respective tailgate doors 102-1 and 102-2 about their respective vertical axes, may be controlled by a tailgate control system 114. In the example where the split-door tailgate assembly 100 includes a powered tailgate hinge 120, activation of the powered tailgate hinge 120 and the movement of the frame member 104 and respective tailgate doors 102-1 and 102-2 about the horizontal axis may be controlled by the tailgate control system 114 as well. The tailgate control system 114 may include a processor and memory that transmit control signals to at least the first powered hinge 106-1 to articulate the first tailgate door 102-1 and the second powered hinge 106-2 to articulate the second tailgate door 102-2. The input to the tailgate control system 114 may come from different numbers of switches. In the example depicted in FIGS. 2A – 3C, the four inputs that trigger the different articulations are provided by three switches 118, which trigger different articulations of the first tailgate door 102-1 and/or the second tailgate door 102-2. However, the different inputs described below may come from various numbers of switches, such as one switch, two switches, four switches, and so on.

The switches 118 may take a variety of forms. For example, the switches 118 may be single-pole switches that selectively open or close a circuit. For example, when a switch 118 is in a state to close a circuit, a signal may be transmitted to the tailgate control system 114 to articulate one or more of the tailgate doors 102-1 and 102-2. By comparison, no signal is transmitted when a switch 118 is in a state where the circuit is open. In another example, a switch 118 may be a capacitive sensor that detects a change in capacitance, which occurs when an operator’s finger contacts the sensor. In this example, a user contacting the capacitive sensor may generate a control signal to the tailgate control system 114, causing it to articulate one or more tailgate doors 102-1 and 102-2. By comparison, no signal is transmitted when the user is not in contact with the capacitive sensor. While particular reference is made to particular switches 118, other types of switches may be implemented in accordance with the principles described herein, including pressure switches that are activated via pressure force and piezoelectric switches.

As depicted in FIG. 2A, the switches 118 may be integrated with either the first tailgate door 102-1 and/or the second tailgate door 102-2. In this example, the tailgate control system 114 may be wirelessly connected or connected by wire to the switches 118, such that when a user operates a particular switch 118, the corresponding tailgate doors 102-1 and 102-2 open or close. In an example, the tailgate control system 114 may wirelessly communicate with switches 118 on a key fob. That is, a key fob may have single pole switches, capacitive sensors, or other types of switches that an operator can actuate to initialize certain tailgate operations (e.g., open a first tailgate door 102-1, open a second tailgate door 102-2, open both tailgate doors, drop connected tailgate doors, etc.).

FIGS. 2A – 2D illustrate one embodiment of input switches 118-1, 118-2, and 118-3 and a control scheme for a tailgate control system 114. As described above, the tailgate control system 114 depicted in FIGS. 2A – 2D may be contained within one of the tailgate doors, such as the first tailgate door 102-1. The tailgate control system 114 controls different components of the split-door tailgate assembly 100 based on input received from various switches 118-1, 118-2, and 118-3, which, as described above, may be positioned at different locations on the tailgate doors 102-1 and 102-2.

For example, a first switch 118-1 may be disposed on an inside portion of the bottom handle of the first tailgate door 102-1. As described above, the first switch 118-1 may be of varying types, including a single-pole mechanical switch, a capacitive switch, a pressure switch, or a piezoelectric switch. In an example, the first switch 118-1 may be covered with a rubber membrane to seal the electronics of the first switch 118-1 from weather and other environmental contaminants.

As described above, the first switch 118-1 may be activated in multiple ways, specifically 1) a long, or above-threshold, actuation and 2) a short, or sub-threshold, actuation. While particular reference is made to a particular parameter that defines the different ways that the first switch 118-1 may be activated (i.e., activation duration), the different ways that the first switch 118-1 may be activated may be based on a different parameter such as the number of pulses in a time frame (i.e., double actuation vs. single actuation).

The various actuation types may activate different components of the split-door tailgate assembly 100. For example, as depicted in FIG. 2D, a short actuation of the first switch 118-1 (e.g., a short depression of a button-type switch 118) may trigger the tailgate control system 114 to activate the first powered hinge 106-1 to articulate (i.e., open or close) the first tailgate door 102-1 and not activate the second powered hinge 106-2. By comparison and as depicted in FIG. 2D, a long actuation of the first switch 118-1 (e.g., a long depression of the button-type switch 118) may trigger the tailgate control system 114 to sequentially activate the first powered hinge 106-1 and the second powered hinge 106-2 to sequentially articulate (i.e., open or close) the first tailgate door 102-1 and the second tailgate door 102-2, respectively.

FIG. 2C depicts the opening of the first tailgate door 102-1 and the second tailgate door 102-2, as may occur when the first switch 118-1 is triggered. Tailgate doors 102-1 and 102-2, as compared to other vehicle doors, pose certain complications for automated opening. For example, tailgate doors 102-1 and 102-2 may have a wider range of motion than passenger doors. Specifically, tailgate doors 102-1 and 102-2 may have ranges of motion greater than 85 or 90 degrees. As such, the powered hinges 106-1 and 106-2 are structured to articulate the first tailgate door 102-1 and the second tailgate door 102-2 through at least 85, and in some cases, greater than 90 degrees of rotational motion.

As described above, each tailgate door 102-1 and 102-2 may articulate about a respective vertical axis 136-1 and 136-2 and is attached to the frame member 104 via a hinge. Via this hinged attachment, the tailgate doors 102-1 and 102-2 may independently rotate about respective vertical axes 136-1 and 136-2 between a closed position, as depicted in FIG. 2A and an open position, as depicted in FIG. 2C.

FIG. 2C also depicts strike plates 238-1 and 238-2 that interact with the respective door latches 110-1 and 110-2 to either allow or prevent rotation of the respective tailgate doors 102-1 and 102-2 about the respective vertical axes 136-1 and 136-2.FIG. 2C also depicts the strike plate 240 that interacts with the inter-door latch 112 to selectively couple the tailgate doors 102-1 and 102-2 together. As depicted in FIG. 2C, the door latches 110-1 and 110-2 and the inter-door latch 112 are disengaged from respective strike plates 238-1, 238-2, and 240, so the tailgate doors 102-1 and 102-2 may swing open about the respective vertical axes 136-1 and 136-2. Also, as depicted in FIG. 2C, the frame latches 108-1 and 108-2 on the frame member 104 are engaged with associated posts on the vehicle frame. In this arrangement, the frame member 104 and mounted tailgate doors 102-1 and 102-2 are prevented from rotating about the horizontal axis 230 depicted in FIG. 2B.

In an example, a second switch 118-2 may be disposed on an inside portion of an upper handle of the first tailgate door 102-1. The second switch 118-2 may be of varying types, including a single-pole mechanical switch, a capacitive switch, a pressure switch, or a piezoelectric switch. In an example, the second switch 118-2 may be covered with a rubber membrane to seal the electronics of the second switch 118-2 from weather and other environmental contaminants.

As depicted in FIG. 2D, actuation of the second switch 118-2 may trigger the tailgate control system 114 to facilitate actuation of the tailgate doors 102-1 and 102-2 about the horizontal axis 230 depicted in FIG. 2B. Facilitating actuation may take a variety of forms. Where the tailgate drop motion is manual, as opposed to being guided by the powered tailgate hinge 120, the tailgate control system 114 may facilitate actuation by disengaging the frame latches 108-1 and 108-2 so that an operator may manually lower the frame member 104 and coupled tailgate doors 102-1 and 102-2. In an example where the tailgate drop motion is powered, the tailgate control system 114 may, in addition to disengaging the frame latches 108-1 and 108-2, activate the powered tailgate hinge 120 to articulate (i.e., open or close) the frame member 104 and coupled tailgate doors 102-1 and 102-2.

FIG. 2B illustrates one embodiment of a split-door tailgate assembly 100 with two tailgate doors 102-1 and 102-2 in a dropped position. In addition to swinging open about vertical axes 136-1 and 136-2, the tailgate doors 102-1 and 102-2 may pivot about a horizontal axis 230, as depicted in FIG. 2B. Specifically, the frame member 104, and the attached tailgate doors 102-1 and 102-2, may articulate about the horizontal axis 230. To facilitate this downward pivot motion, the frame member 104 may be attached to the frame of the vehicle in various ways. For example, the frame member 104 may include a protrusion 232 on either lateral side. This protrusion 232 fits within a socket 234 on the vertical sidewall of the truck bed 116. For simplicity, the protrusion/socket connection is depicted on one side of the frame member 104 with reference numbers. However, a similar arrangement may be found on the other side of the frame member 104. This connection facilitates rotation of the frame member 104 about the horizontal axis 230, which is defined by the axis of the protrusion 232 and socket 234. That is, via this hinged attachment, the frame member 104 may rotate about the horizontal axis 230 between a closed position, as depicted in FIG. 2A and an open position, as depicted in FIG. 2B.

FIG. 2B also depicts the arrangement of various other components of the split-door tailgate assembly 100 to facilitate the pivoting about the horizontal axis 230. Specifically, FIG. 2B depicts the rods 242-1 and 242-2, which interact with the respective frame latches 108-1 and 108-2 to either allow or prevent rotation of the frame member 104 about the horizontal axis 230. As depicted in FIG. 2B, the frame latches 108-1 and 108-2 are disengaged, allowing the frame member 104 and tailgate doors 102-1 and 102-2 to swing downward about the horizontal axis 230.

Also as depicted in FIG. 2B, the door latches 110-1 and 110-2 on the respective tailgate doors 102-1 and 102-2 are engaged with associated strike plates 238-1 and 238-2 on the frame member 104. In this configuration, the tailgate doors 102-1 and 102-2 are prevented from rotating about the respective vertical axes 136-1 and 136-2.

As depicted in FIG. 2C, a third switch 118-3, may be disposed on the second tailgate door 102-2 side panel. The third switch 118-3 may be of varying types, including a single-pole mechanical switch, a capacitive switch, a pressure switch, or a piezoelectric switch. In an example, the third switch 118-3 may be covered with a rubber membrane to seal the electronics of the third switch 118-3 from weather and other environmental contaminants. Note that while FIGS. 2A – 2C depict a particular physical structure and shape for the strike plates 238-1, 238-2, and 240 and rods 242-1 and 242-1, strike plates and rods with other physical structures may be implemented in accordance with the principles described herein.

As depicted in FIG. 2D, actuation of the third switch 118-3 may trigger the tailgate control system 114 to activate the second powered hinge 106-2 to articulate (i.e., open or close) the second tailgate door 102-2.

Returning to FIG. 2A, a key fob 228 may also include instances of switches 118-1, 118-2, and 118-3. That is to say, operator actuation of the key fob switches 118-1, 118-2, and 118-3 may articulate the same combinations of tailgate doors 102-1 and 102-2 as their counterpart switches 118-1, 118-2, and 118-3 disposed on the vehicle. In this case, the tailgate control system 114 may include a wireless transceiver to communicate with the key fob 228 using various protocols, including radio frequency (RF), near-field communication (NFC), infrared (IR), dedicated short-range communication (DSRC), Wi-Fi, or Bluetooth®. Again, while FIG. 2A depicts instances of three switches 118-1, 118-2, and 118-3, the key fob 228 may include any number of switches, with different actuations of the different number of switches providing the movements described herein.

In an example, the tailgate control system 114 may interrupt or block tailgate door actuation based on sensor output, which sensor output is indicative of an obstacle, such as an object or a human. That is, the vehicle may include a variety of sensors. Examples include a camera 222, a millimeter wave (mm-wave) radar sensor 224, and sonar sensors 226-1 and 226-2. These sensors generally identify objects in the surrounding environment of the vehicle, specifically behind the vehicle along a path of the tailgate doors 102-1 and 102-2. The sensors transmit a signal to the tailgate control system 114, which can interrupt an active articulation of the tailgate doors 102-1 and 102-2 or block the initialization of a requested articulation of the tailgate doors 102-1 and 102-2. Accordingly, a sensor-based articulation of the tailgate doors 102-1 and 102-2 may ensure the safe operation of the tailgate doors 102-1 and 102-2, prevent damage to objects and/or the vehicle, and prevent potential injury to an operator. Note that while FIG. 2A depicts specific sensors positioned at specific locations, the split-door tailgate assembly 100 may include other types of sensors located at different areas of the tailgate region.

FIG. 2D depicts a table 244, which defines the actuation control signals generated based on different inputs. As described above, responsive to a short actuation of a first switch 118-1, the tailgate control system 114 may articulate (open/close) the first tailgate door 102-1 about its vertical axis 136-1 while the second tailgate door 102-2 is not. Responsive to a long actuation of the first switch 118-1, the tailgate control system 114 may sequentially articulate (open/close) the first tailgate door 102-1 about its vertical axis 136-1 and the second tailgate door 102-2 about its vertical axis 136-2. As described above, a short articulation may be defined as a sub-threshold actuation of the first switch 118-1, which threshold may be a variety of durations, including half a second, one second, or two seconds, among others. By comparison, a long articulation may be defined as an above-threshold actuation of the first switch 118-1.

Similarly, as described above, responsive to any actuation of the second switch 118-2, the tailgate control system 114 may facilitate the actuation of both the first tailgate door 102-1 and the second tailgate door 102-2 about a horizontal axis 230. In one example, the tailgate control system 114 may disengage the frame latches 108-1 and 108-2 to facilitate horizontal pivoting. In an example, the tailgate control system 114 may engage a powered tailgate hinge 120 to articulate the frame member 104 and the tailgate doors 102-1 and 102-2. Responsive to any actuation of the third switch 118-3, the tailgate control system 114 may articulate (open/close) the second tailgate door 102-2 about its vertical axis 136-2. Note that FIG. 2D depicts example actuations of three switches 118-1, 118-2, and 118-3, the control system may control the different articulations of the different tailgate doors 102-1 and 102-2 based on different inputs from any number of switches. For example, there may be one vehicle-mounted switch and one key fob 228 switch, which may be activated in four different ways to provide the different articulations described herein.

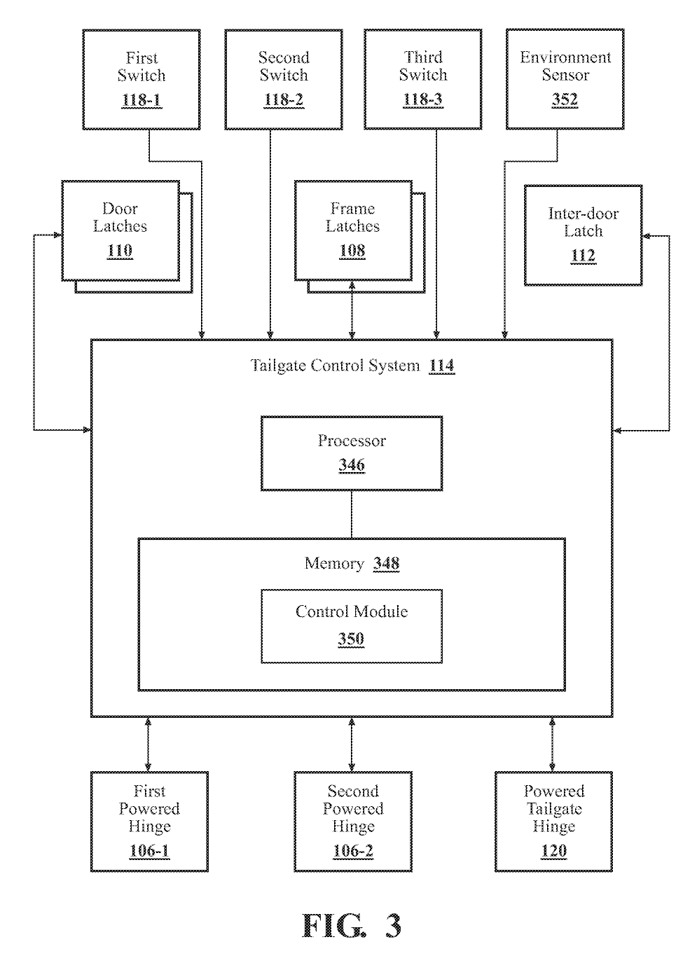

FIG. 3 illustrates one embodiment of a tailgate control system 114 that is associated with articulating tailgate doors 102-1 and 102-2. The tailgate control system 114 is shown as including a processor 346. In one or more arrangements, the processor 346 can be a primary/centralized processor or may be representative of many distributed processing units. In an example, the tailgate control system 114 can be an electronic control unit (ECU). Alternatively, or additionally, the processors include a central processing unit (CPU), an application-specific integrated circuit (ASIC), a microcontroller, a system on a chip (SoC), and/or other electronic processing units that support operation of the tailgate control system 114.

In one embodiment, the tailgate control system 114 includes a memory 348 that stores a control module 350. The memory 348 can include volatile and/or non-volatile memory. The memory 348 may be random-access memory (RAM), read-only memory (ROM), PROM (Programmable Read-Only Memory), EPROM (Erasable Programmable Read-Only Memory), EEPROM (Electrically Erasable Programmable Read-Only Memory), a register, a magnetic disk, an optical disk, a hard-disk drive, a flash memory, a solid-state drive (SSDs), and/or another suitable memory for storing the control module 350. The control module 350 is, for example, machine-readable instructions that, when executed by the processor 346, cause the processor 346 to perform the various functions disclosed herein. In alternative arrangements, the control module 350 is an independent element from the memory 348 that is, for example, comprised of hardware elements. Thus, control module 350 is alternatively an ASIC, a hardware-based controller, a composition of logic gates, or another hardware-based solution.

As described previously, the tailgate control system 114 may include a control module 350. In at least one arrangement, the control module 350 is implemented as non-transitory machine-readable instructions that, when executed by the processor 346, implement one or more of the various functions described herein. In various arrangements, the control module 350 is a component of the processor(s) 346, or the control module 350 is executed on and/or distributed among other processing systems to which the processor(s) 346 is operatively connected. Alternatively, or in addition, the control module 350 is implemented, at least partially, within hardware. For example, the control module 350 may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, the control module 350 can be distributed among a plurality of the modules described herein.

The tailgate control system 114 includes a control module 350 that includes instructions that, when executed by the processor 346, cause the processor 346 to sequentially pivot a first tailgate door 102-1 and a second tailgate door 102-2 of a split-door tailgate assembly 100 about respective vertical axes 136-1 and 136-2 responsive to a first input. As described above, the first input may be a first input type from a first switch 118-1. The control module 350 also includes instructions that, when executed by the processor 346, cause the processor 346 to pivot the first tailgate door 102-1 about a first vertical axis 136-1 responsive to a second input, which second input may be a second input type from the first switch 118-1 or another switch.

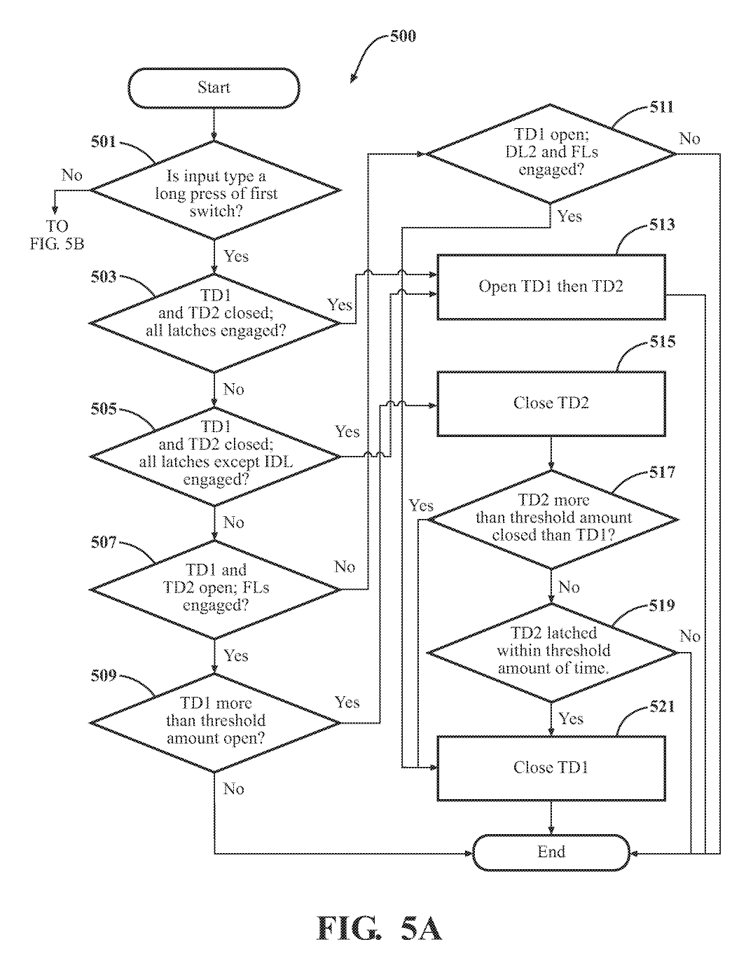

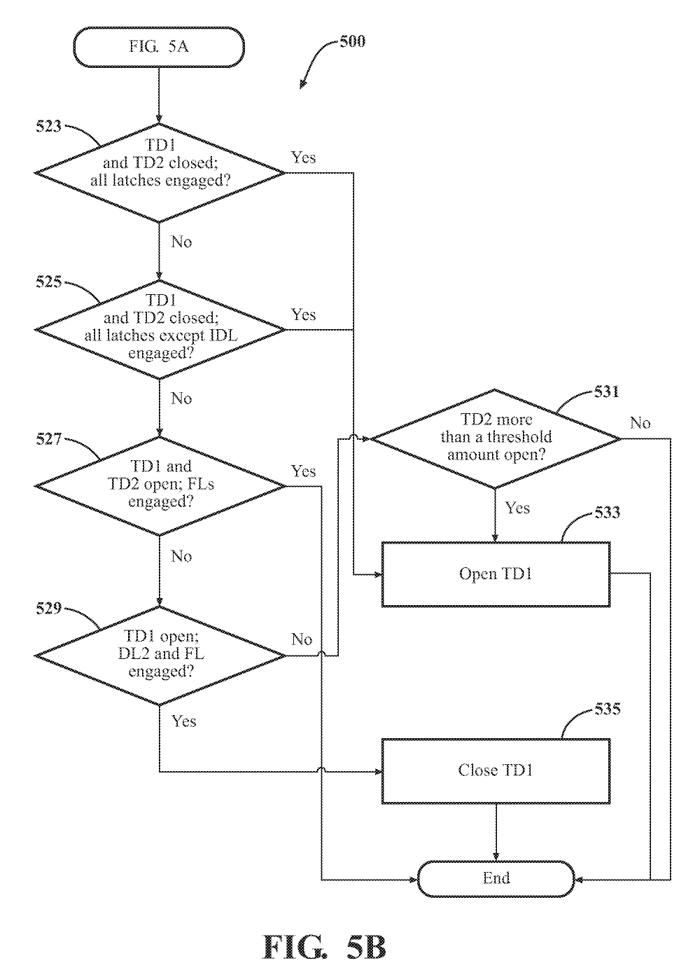

As described above, the first switch 118 may receive different types of actuation. In one example, the different input types are classified by the duration of the activation by the operator. In another example, the different input types of actuation may be classified by other parameters. In a duration-based example, the control module 350 includes instructions that cause the processor 346 to 1) sequentially pivot the first tailgate door 102-1 and the second tailgate door 102-2 responsive to a long pulse from the first switch 118-1 and 2) pivot the first tailgate door 102-1 about the first vertical axis 136-1 responsive to a short pulse from the first switch 118-1. That is, the control module 350 includes instructions to transmit a control signal to a first powered hinge 106-1 within the first tailgate door 102-1 and/or transmit a control signal to a second powered hinge 106-2 within the second tailgate door 102-2 based on the type of input received from the first switch 118-1. Additional details regarding the operation of the tailgate control system 114 to articulate the tailgate doors 102-1 and 102-2 based on the first input are provided below in connection with FIGS. 5A and 5B.

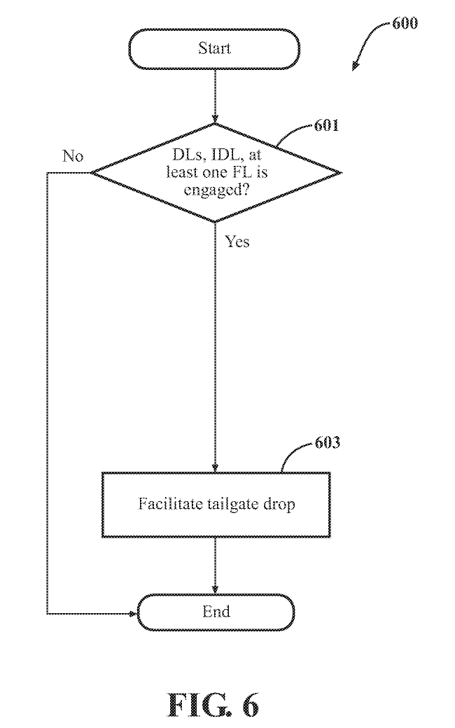

The control module 350 also includes instructions that, when executed by the processor 346, cause the processor 346 to disengage frame latches 108-1 and 108-2 to facilitate a pivot of the first tailgate door 102-1 and the second tailgate door 102-2 about a horizontal axis 230 responsive to a third input, which third input may be an input from the second switch 118-2, the first switch 118-1, or another switch. In an example where the frame member 104 is motor-powered to pivot about the horizontal axis 230, the control module 350 includes instructions that cause the processor 346 to transmit a control signal to a powered tailgate hinge 120 to lower the frame member 104, along with the first tailgate door 102-1 and the second tailgate door 102 that are coupled together via the inter-door latch 112, about the horizontal axis 230. Additional details regarding the operation of the tailgate control system 114 to articulate the tailgate doors 102-1 based on the second input are provided below in connection with FIG. 6.

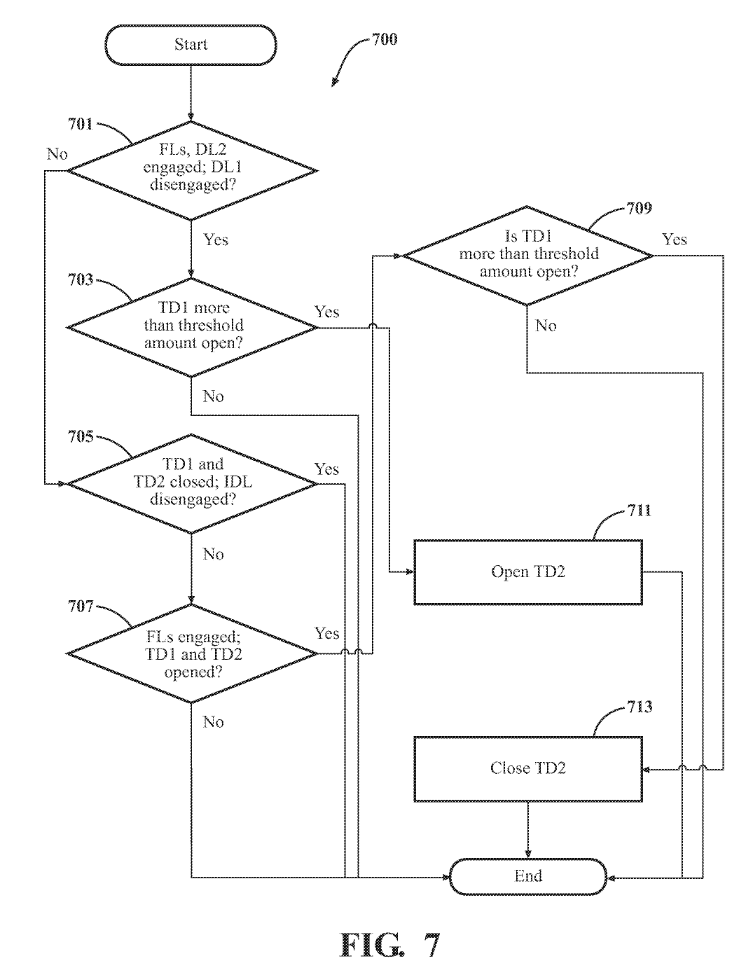

The control module 350 also includes instructions that, when executed by the processor 346, cause the processor 346 to pivot the second tailgate door 102-2 about a second vertical axis 136-2 responsive to a fourth in input, which fourth input may be an input from a third switch 118-3, the second switch 118-2, the first switch 118-1, or another switch. That is, the control module 350 includes instructions to transmit a control signal to a second powered hinge 106-2 within the second tailgate door 102-2 based on the input received. Additional details regarding the operation of the tailgate control system 114 to articulate the second tailgate door 102-2 based on the third input are provided below in connection with FIG. 7.

In any of these examples, the control module 350 may articulate the tailgate doors 102-1 and 102-2 based on the state of the tailgate doors 102-1 and 102-2. For example, it may be dangerous to allow the frame member 104 and tailgate doors 102-1 and 102-2 to swing down when the tailgate doors 102-1 and 102-2 are not coupled together. That is, either tailgate door may swing about its vertical axis 136-1 and 136-2 while being rotated about the horizontal axis 230, which may cause damage to the tailgate doors 102-1 and 102-2, other components of the vehicle, or nearby objects, and may harm an operator. As another example, it may be dangerous to allow the tailgate doors 102-1 and 102-2 to swing outward about their vertical axes 136-1 and 136-2 when the frame member 104 is not latched in a vertical orientation, as the frame member 104 may swing down as the tailgate doors 102-1 and 102-2 are swung out. As another example, the tailgate doors 102-1 and 102-2 may open and close in a particular sequence. For example, due to the arrangement of the inter-door latch 112 on the first tailgate door 102-1 and the strike plate 240 on the second tailgate door 102-2, as depicted in FIG. 2C, it may be that the first tailgate door 102-1 cannot be closed before the second tailgate door 102-2.

For these and other reasons, the control module 350 coordinates the articulation of the tailgate doors 102-1 and 102-2 based on the state of the tailgate doors 102-1 and 102-2. Specifically, the control module 350 may include instructions that cause the processor 346 to determine the state of the first tailgate door 102-1 and the state of the second tailgate door 102-2. The state of the tailgate doors 102-1 and 102-2 may be determined based on a first frame latch 108-1 state, a second frame latch 108-2 state, a first door latch 110-1 state, a second door latch 110-2 state, and an inter-door latch 112 state. Additionally or alternatively, the state of the tailgate doors 102-1 and 102-2 may be determined based on the tailgate door positions. Specifically, the state of the first tailgate door 102-1 may be based on a first tailgate door position and the state of the second tailgate door 102-2 may be based on a second tailgate door position Additional details regarding how the state of the different latches and/or door position affect the articulation of the tailgate doors 102-1 and 102-2 are described below in connection with FIGS. 5A, 5B, 6 and 7.

As described above, it may be that the articulation of the tailgate doors 102-1 and 102-2 in the ways described herein may be dangerous to objects and individuals in the vicinity of the vehicle. For example, a user may be standing behind the truck bed in the swing path of a closing tailgate door 102-1 and 102-2. Were the tailgate doors 102-1 and 102-2 not stopped, the user may become pinched or otherwise injured. Accordingly, in this example, the vehicle may be equipped with various environment sensors 352, such as the camera 222, mm-wave radar sensor 224, and sonar sensors 226-1 and 226-2, to name a few. When these environment sensors 352 detect an obstacle in the door path, the control module 350 may halt the movement of the tailgate doors 102-1 and 102-2. For example, the powered hinges 106-2 and 106-2 and the powered tailgate hinge 120 may include brake assemblies that stop the movement of the check arm 107-1 and 107-2 or the respective motors. As such, the control module 350 may include instructions that cause the processor 346 to interrupt or block the initialization of articulation of the tailgate doors 102-1 and 102-2 (either opening or closing) based on an output from a vehicle environment sensor 352 detecting an obstruction in the door path. In this example, the control module 350 may include instructions that cause the processor 346 to resume the articulation based on the output of the environment sensors 352 that indicate the obstruction has cleared the door path.

In another example, a user may manually interrupt the articulation of the tailgate doors 102-1 and 102-2. In this case, rather than relying on the sensors, the control module 350 may include instructions that cause the processor 346 to interrupt the articulation based on an input at a switch that initiated the articulation. For example, a user may depress the second switch 118-2 on the key fob 228 to lower the frame member 104 and the mounted tailgate doors 102-1 and 102-2. However, the user may notice a shopping cart directly behind the vehicle. Accordingly, by depressing the second switch 118-2 a second time, the tailgate control system 114 may stop the powered tailgate hinge 120 from further lowering the frame member 104 and the mounted tailgate doors 102-1 and 102-2. In this example, the control module 350 may include instructions that cause the processor 346 to resume the articulation responsive to an input at the switch that initiated the articulation. Returning to the above example, the user may again depress the second switch 118-2 on the key fob 228 once the shopping cart has been moved, allowing the powered tailgate hinge 120 to continue lowering the frame member 104 and the mounted tailgate doors 102-1 and 102-2.

As such, the tailgate control system 114 provides hands-free, automated, and safe opening and closing of various tailgate doors 102-1 and 102-2 of a split-door tailgate assembly 100.

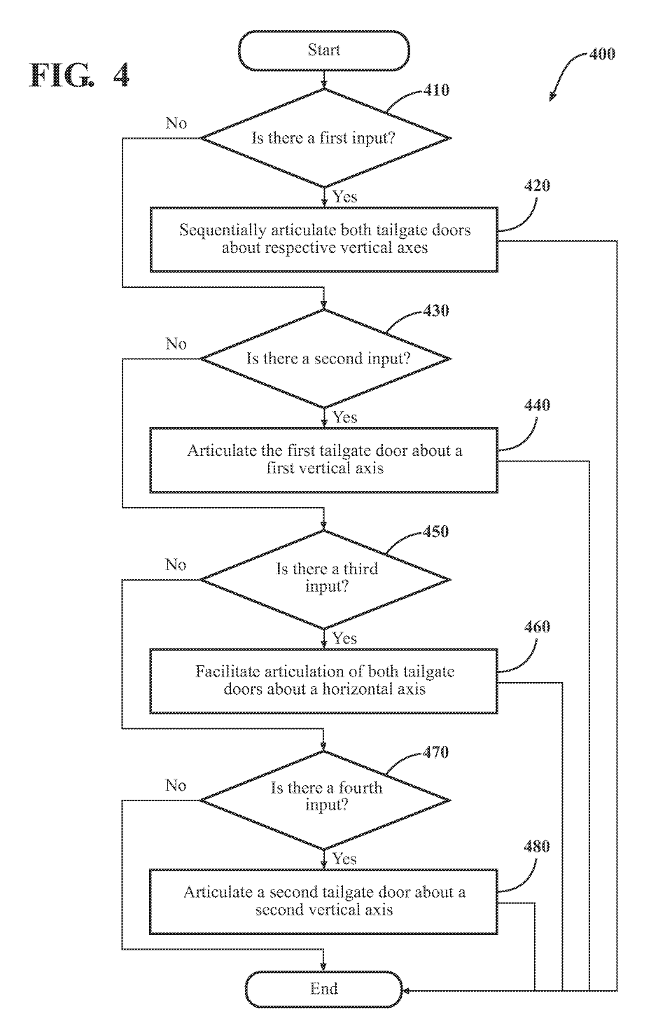

Additional aspects of operating a split-door tailgate assembly 100 will be discussed in relation to FIG. 4. FIG. 4 illustrates a flowchart of a method 400 that is associated with coordinating the movement of tailgate doors 102-1 and 102-2 of the split-door tailgate assembly 100. Method 400 will be discussed from the perspective of the tailgate control system 114 of FIG. 3. While method 400 is discussed in combination with the tailgate control system 114, it should be appreciated that the method 400 is not limited to being implemented within the tailgate control system 114 but is instead one example of a system that may implement the method 400.

As described above, the tailgate control system 114 coordinates tailgate door movement based on input from switches, each switch input triggering a specific target tailgate door movement. Accordingly, the method 400, in general, ensures that the targeted tailgate door movement is executed safely and as expected.

At 410, the tailgate control system 114 determines whether a first input is received. As described above, the first input may be a first input type at a first switch 118-1, which first input type may be a long depression of a first switch 118-1, which first switch may be disposed on the vehicle itself or a key fob 228. If there is a first input (e.g., a first input type at the first switch 118-1) (block 410, determination YES), at 420, the tailgate control system 114 sequentially articulates both tailgate doors 102-1 and 102-2 about respective vertical axes 136-1 and 136-2 as described above and as described in greater detail below in connection with FIG. 5A. Note that the direction of articulation (i.e., opening or closing) is based on the current position of both the tailgate doors 102-1 and 102-2 as described in FIG. 5A.

If there is no first input (e.g., no first input type at the first switch 118-1) (block 410, determination NO), then at 430, the tailgate control system 114 determines whether a second input (e.g., a second input type at the first switch 118-1, which second input type may be a short depression of a first switch 118-1). If there is a second input (e.g., a second input type at the first switch 118-1) (block 430, determination YES), at 440, the tailgate control system 114 may articulate the first tailgate door 102-1 about the first vertical axis 136-1 as described above and as described in greater detail below in connection with FIG. 5B.

If no second input is received (block 430, determination NO), then at 450, the tailgate control system 114 determines whether a third input has been received. As described above, the third input may be an input received at a second switch 118-2. If there is a third input (e.g., an input at the second switch 118-2) (block 450 determination YES), at 460, the tailgate control system 114 may facilitate the articulation of the tailgate doors 102-1 and 102-2 about a horizontal axis 230 as described above and as described in greater detail below in connection with FIG. 6.

If there is no third input (block 450, determination NO), at 470, the tailgate control system 114 determines whether a fourth input is received. As described above, the fourth input may be an input at a third switch 118-3. If there is a fourth input (e.g., an input of a third switch 118-3) (block 470 determination YES), at 480, the tailgate control system 114 may articulate the second tailgate door 102-2 about the second vertical axis 136-2 as described above and as described in greater detail below in connection with FIG. 7.

FIGS. 5A and 5B illustrate a flowchart 500 of one embodiment for articulating tailgate doors 102-1 and 102-2 based on inputs from a first switch 118-1. As described above, the tailgate control system 114 sequentially pivots the first tailgate door 102-1 and the second tailgate door 102-2 about respective vertical axes 136-1 and 136-2 responsive to a first input (e.g., a first input type at a first switch 118-1). More specifically, the tailgate control system 114 includes instructions that cause the processor 346 to 1) sequentially open the first tailgate door 102-1 and the second tailgate door 102-2 responsive to the first tailgate door 102-1 being in a closed state and the second tailgate door 102-2 being in the closed state, 2) sequentially close the second tailgate door 102-2 and the first tailgate door 102-1 responsive to the first tailgate door 102-1 being in an open state and the second tailgate door 102-2 being in the open state, and 3) close the first tailgate door 102-1 responsive to the first tailgate door 102-1 being in the open state and the second tailgate door 102-2 being in the closed state. As described above, the “state” of each tailgate door may be determined based on the states (i.e., engaged or disengaged) of the various latches and/or the door positions. FIG. 5A describes the sequential pivoting of the tailgate doors 102-1 and 102-2 based on latch states.

First, at 501, the tailgate control system 114 determines whether a long press of the first switch 118-1 has been received. If not (block 501, determination NO), the tailgate control system 114 performs the operations depicted in FIG. 5B to articulate just the first tailgate door 102-1. If the input is a long press of the first switch 118-1 (block 501, determination YES), at 503, the tailgate control system 114 determines whether the first tailgate door (TD1) 102-1 and the second tailgate door (TD2) 102-2 are closed and whether all latches (i.e., the first frame latch (FL1) 108-1, the second frame latch (FL2) 108-2, the first door latch (DL1) 110-1, the second door latch (DL2) 110-2, and the inter-door latch (IDL) 112) are engaged. In this state, both tailgate doors 102-1 and 102-2 may be in the “closed” state. If these conditions are met (block 503, determination YES), at 513, the tailgate control system 114 may open the first tailgate door 102-1 and then open the second tailgate door 102-2. For example, opening the first tailgate door 102-1, followed by the second tailgate door 102-2, may involve opening the second tailgate door 102-2 after the first tailgate door 102-1 reaches a certain threshold, such as 1%, of its fully open position. As described above, opening the tailgate doors 102-1 and 102-2 may involve activating the respective powered hinges 106-1 and 106-2.

As described above, determining whether a door is open may be based on its position. In an example, a door position may be determined by counting the steps of a motor of the respective powered hinge 106-1 and 106-2. For example, the first tailgate door 102-1 may operate from a fully closed position (i.e., 0 degrees of rotation) to a fully open position (e.g., 90 degrees of rotation). Each angular position of the first tailgate door 102-1 may be mapped to a step count of the motor of the first powered hinge 106-1. Accordingly, the processor 346 of the tailgate control system 114 may determine that the first tailgate door 102-1 is within 1% of full open when the motor of the first powered hinge 106-1 has a step count that is 1% of the step count that is mapped to a fully open angular position of the first tailgate door 102-1.

Returning to FIG. 5A, if the first tailgate door 102-1 and the second tailgate door 102-2 are not closed and all latches are not engaged (block 503, determination NO), at 505 the tailgate control system 114 may determine whether the first tailgate door 102-1 and the second tailgate door 102-2 are closed and all latches except the inter-door latch 112 are engaged. In this state, both tailgate doors 102-1 and 102-2 may still be in the “closed” state, although they are not latched together via the inter-door latch 112. If the first tailgate door 102-1 and the second tailgate door 102-2 and all latches except the inter-door latch 112 are engaged (block 505, determination YES), at 513, the tailgate control system 114 may open the first tailgate door 102-1 and then open the second tailgate door 102-2 as described above.

If these conditions are not met (block 505, determination NO), at 507, the tailgate control system 114 determines if the first tailgate door 102-1 and the second tailgate door 102-2 are open and if the frame latches 108-1 and 108-2 are engaged. In this state, both tailgate doors 102-1 and 102-2 are in an “open” state, and the frame member 104 is latched to the vehicle body rather than being in a lowered position. In general, in this state, it may be desirable to close the tailgate doors 102-1 and 102-2. However, the order of closing the tailgate doors 102-1 and 102-2 may have a particular sequence, as described above. Accordingly, some steps in the method ensure the tailgate doors 102-1 and 102-2 close in the correct sequence.

If both doors are open (block 507, determination YES), at 509, the tailgate control system 114 determines if the first tailgate door 102-1 is more than a threshold amount open. As described above, this may involve determining whether the motor of the first powered hinge 106-1 has a step count higher than the step count that corresponds to a threshold angular position of the first tailgate door 102-1. This threshold angular position may be any amount, for example, 180 degrees from a reference position, which reference position may be when the first tailgate door 102-1 is fully closed. As a more specific example, the threshold angular position may be any of the following values: 90 degrees, 80 degrees, 70 degrees, 60 degrees, 50 degrees, 40 degrees, 30 degrees, 20 degrees, 10 degrees, or any other value. If the first tailgate door is not more than the threshold amount open (block 509, determination NO), the tailgate control system 114 may prevent the closing of the second tailgate door 102-2 as doing so may cause the second tailgate door 102-2 to slam into the first tailgate door 102-1. That is, the first tailgate door 102-1 may be in the door path of the second tailgate door 102-2.

If the first tailgate door 102-1 is more than the threshold amount open (block 509, determination YES), at 515, the tailgate control system 114 may close the second tailgate door 102-2, for example, by activating the second powered hinge 106-2.

While closing the second tailgate door 102-2, at 517, the tailgate control system 114 may determine if, before latching the second tailgate door 102-2, the second tailgate door 102-2 is more than a threshold amount closed than the first tailgate door 102-1. As a specific example, the tailgate control system 114 may determine if the second tailgate door 102-2 is at an angular position that is less than 25% of the angular position of the first tailgate door 102-1. If so (block 517, determination YES), at 521, the tailgate control system 114 may close the first tailgate door 102-1 by activating the first powered hinge 106-1. While particular reference is made to a particular threshold, the tailgate control system 114 may determine a variety of relative angular positions of the first tailgate door 102-1 and the second tailgate door 102-2.

If the second tailgate door 102-2 is not more than a threshold amount closed than the first tailgate door 102-1 (e.g., at an angular position that is more than 25% of the angular position of the first tailgate door 102-1) (block 517, determination NO), at 519 the tailgate control system 114 may determine if the second tailgate door 102-2 becomes latched within a threshold time (e.g., 10 seconds) of the requested operation to close the second tailgate door 102-2. If so (block 519, determination YES), at 521, the tailgate control system 114 may close the first tailgate door 102-1. If not (block 519, determination NO), this may indicate some malfunction with the tailgate door closing or that the second tailgate door 102-2 has not yet closed. In this case, the tailgate control system 114 may refrain from executing any articulation.

Returning to block 507, if the conditions are not satisfied (i.e., the first tailgate door 102-1 and the second tailgate door 102-2 are not both open and the frame latches 108-1 and 108-2 are not both engaged) (block 507, determination NO), this may indicate that one of the tailgate doors is opened and one is closed. Accordingly, at 511 the tailgate control system 114 determines whether the first tailgate door 102-1 is opened (i.e., based on latch states and/or the first door position), whether the second tailgate door 102-2 is closed (i.e., based on latch states and/or the second door position), and whether the frame latches 108-1 and 108-2 are engaged. If this is the case (block 511, determination YES), at 521, the tailgate control system 114 may close the first tailgate door 102-1. If this is not the case (block 511, determination NO), it may be the case that the second tailgate door 102-2 is open while the first tailgate door 102-1 is closed. In this condition, automatically closing the second tailgate door 102-2 may result in the second tailgate door 102-2 slamming against the first tailgate door 102-1 (potentially damaging either door) and not latching shut. Accordingly, in this case, the tailgate control system 114 may refrain from closing the second tailgate door 102-2 when the first tailgate door 102-1 is already closed, thereby preventing the second tailgate door 102-2 from slamming.

Turning to FIG. 5B, as described above, the tailgate control system 114 pivots the first tailgate door 102-1 about the first vertical axis 136-1 responsive to a second input (e.g., a second input type at the first switch 118-1). In an example, the tailgate control system 114 includes instructions that cause the processor 346 to 1) open the first tailgate door 102-1 responsive to the first tailgate door 102-1 being in a closed state and the second tailgate door 102-2 being in the closed state, 2) close the first tailgate door 102-1 responsive to the first tailgate door 102-1 being in an open state and the second tailgate door 102-2 being in the closed state, and 3) open the first tailgate door 102-1 responsive to the first tailgate door 102-1 being in the closed state and the second tailgate door 102-2 being in the open state. FIG. 5B depicts the pivoting of the first tailgate door 102-1 based on latch states.

As described above, if the input is not of the first type (e.g. a long press of the first switch 118-1) (block 501, determination NO) (e.g., it is a short press of the first switch 118-1), at 523, the tailgate control system 114 determines whether the first tailgate door (TD1) 102-1 and the second tailgate door (TD2) 102-1 are closed and all latches (i.e., the first frame latch (FL1) 108-1, the second frame latch (FL2) 108-2, the first door latch (DL1) 110-1, the second door latch (DL2) 110-2, and the inter-door latch (IDL) 112 are closed. In this state, both tailgate doors 102-1 and 102-2 may be in the “closed” state. If both doors are in the closed state and all latches are engaged (block 523, determination YES), at 533, the tailgate control system 114 may open the first tailgate door 102-1 about the first vertical axis 136-1 by activating the first powered hinge 106-1.

If the first tailgate door 102-1 and the second tailgate door 102-2 are not closed and all latches are not engaged (block 523, determination NO), at 525, the tailgate control system 114 may determine whether the first tailgate door 102-1 and the second tailgate door 102-2 are closed and all latches except the inter-door latch 112 are engaged. In this state, both tailgate doors 102-1 and 102-2 may still be in the “closed” state, although they are not latched together via the inter-door latch 112. If the first tailgate door 102-1 and the second tailgate door 102-2 are closed and all latches except the inter-door latch 112 are engaged (block 525, determination YES), at 533, the tailgate control system 114 may open the first tailgate door 102-1 by activating the first powered hinge 106-1.

If these conditions are not met (block 525, determination NO), at 527, the tailgate control system 114 determines whether the first tailgate door 102-1 and the second tailgate door 102-2 are open and whether the frame latches 108-1 and 108-2 are engaged. In this state, both tailgate doors 102-1 and 102-2 are in an “open” state, and the frame member 104 is latched to the vehicle body. If both doors are in the open state and the frame latches 108-1 and 108-2 are engaged (block 527, determination YES), the tailgate control system 114 may refrain from closing the first tailgate door 102-1. This may be due to a closing order for the split-door tailgate assembly 100, where the second tailgate door 102-2 is to close first. In this case, closure of the first tailgate door 102-1 while the second tailgate door 102-2 is open may result in a failure to properly latch the second tailgate door 102-2 to the frame member 104 upon closing due to the position of the already closed first tailgate door 102-1.

If these conditions are not met (block 527, determination NO) (e.g., one of the tailgate doors is open and the other is closed), at 529, the tailgate control system 114 may determine if the first tailgate door 102-1 is in an open state, the second tailgate door 102-2 is in a closed state (i.e., the second door latch 110-2 is engaged and/or the second tailgate door position indicates the second tailgate door 102-2 is closed) and if the frame latches 108-1 and 108-2 are engaged. If yes, this may indicate that the second tailgate door 102-2 is in a closed state and the first tailgate door 102-1 is in an open state. If the first tailgate door 102-1 is in the open state and the second tailgate door 102-2 is in the closed state (block 529, determination YES), at 535, the tailgate control system 114 may close the first tailgate door 102-1 by activating the first powered hinge 106-1.

If these conditions are not met (block 529, determination NO), it may indicate that the second tailgate door 102-2 is in an open state and the first tailgate door 102-1 is in a closed state. However, before opening the first tailgate door 102-1, at 531, the tailgate control system 114 may determine whether the second tailgate door 102-2 is more than a threshold amount open. As described above, this may involve determining whether the motor of the second powered hinge 106-2 has a step count that exceeds the step count corresponding to a threshold angular position of the second tailgate door 102-2. This threshold angular position may be any amount, for example, 180 degrees, 90 degrees, 80 degrees, 70 degrees, 60 degrees, 50 degrees, 40 degrees, 30 degrees, 20 degrees, 10 degrees or any other amount from a reference position, which reference position may be when the second tailgate door 102-2 is fully closed. In any case, the threshold angular position may indicate that the second tailgate door 102-2 is at an angular position where the first tailgate door 102-1 will not contact the second tailgate door 102-2 upon opening (i.e., that the second tailgate door 102-2 is not in a door path of the first tailgate door 102-1).

If the second tailgate door 102-2 is not more than the threshold amount open (block 531, determination NO), the tailgate control system 114 may prevent any door articulation as opening the first tailgate door 102-1 as in this configuration with the second tailgate door 102-2 being less than the threshold amount open, may cause the first tailgate door 102-1 to slam into the second tailgate door 102-2. If the second tailgate door 102-2 is more than the threshold amount open (531, determination YES), at 533, the tailgate control system 114 may open the first tailgate door 102-1 by activating the first powered hinge 106-1.

FIG. 6 illustrates a flowchart 600 of one embodiment for articulating tailgate doors 102-1 and 102-2 based on a third input (e.g., an input from a second switch 118-2). As described above, the tailgate control system 114 facilitates the pivoting of the frame member 104 and mounted tailgate doors 102-1 and 102-2 about a horizontal axis 230 responsive to a third input (e.g., an input at a second switch 118-2 or a third input type from a first switch 118-1). In an example, the tailgate control system 114 includes instructions that cause the processor 346 to disengage frame latches 108-1 and 108-2 of the frame member 104, to which the tailgate doors 102-1 and 102-2 are mounted responsive to 1) the first tailgate door 102-1 being in a closed state, 2) the second tailgate door 102-2 being in the closed state, and 3) an inter-door latch 112 being engaged. FIG. 6 depicts the pivoting downward of the frame member 104 and mounted tailgate doors 102-1 and 102-2.

At 601, the tailgate control system 114 determines whether the first door latch (DL1) 110-1, the second door latch (DL2) 110-2, the inter-door latch (IDL) 112, and at least one frame latch 108-1 and 108-2 are in an engaged position. In this state, both tailgate doors 102-1 and 102-2 may be in the “closed” state and latched together. If this is the case (block 601, determination YES), at 603, the tailgate control system 114 may facilitate the tailgate drop, which may include releasing the frame latches 108-1 and 108-2, allowing a user to drop the split-door tailgate assembly 100 manually. In the case where the split-door tailgate assembly 100 exhibits powered movement, facilitating the tailgate drop may include activating the powered tailgate hinge 120 to lower the split-door tailgate assembly 100.

If the first door latch (DL1) 110-1, the second door latch (DL2) 110-2, the inter-door latch (IDL) 112, and at least one frame latch 108-1 and 108-2 are not all in an engaged position (block 601, determination NO), the tailgate control system 114 may interrupt or block any tailgate drop as doing so may result in an injury to an individual or damage to an object. For example, were any door latch 110-1 and 110-2 or the inter-door latch 112 not engaged, either tailgate door 102-1 and 102-2 may swing outward as the split-door tailgate assembly 100 is swung downward.

FIG. 7 illustrates a flowchart 700 of one embodiment for articulating tailgate doors 102-1 and 102-2 based on a fourth input (e.g., an input from a third switch 118-3). As described above, the tailgate control system 114 pivots the second tailgate door 102-2 about the second vertical axis 136-2. In an example, the tailgate control system 114 includes instructions that cause the processor 346 to 1) open the second tailgate door 102-2 responsive to the first tailgate door 102-1 being in an open state and the second tailgate door 102-2 being in a closed state and 2) close the second tailgate door 102-2 responsive to the first tailgate door 102-1 being in the open state and the second tailgate door 102-2 being in the open state. FIG. 7 depicts the pivoting of the second tailgate door 102-2 based on latch states.

First at 701, the tailgate control system 114 determines whether the frame latches 108-1 and 108-2 and second door latch 110-2 are engaged and the first door latch 110-1 is disengaged and/or whether 1) the first tailgate door 102-1 position indicates the first tailgate door 102-1 is open and 2) the second tailgate door 102-2 position indicate the second tailgate door 102-2 is closed. In this arrangement, the first tailgate door 102-1 may be in an open state, and the second tailgate door 102-2 may be in a closed state. If this is the case (block 701, determination YES), at 703, the tailgate control system 114 may determine if the first tailgate door 102-1 is more than a threshold amount open. As described above, this may involve determining whether the motor of the first powered hinge 106-1 has a step count higher than the step count that corresponds to a threshold rotational position of the first tailgate door 102-1. This threshold rotational position may be any amount, for example, between 0 and 180 degrees from a reference position, which reference position may be when the first tailgate door 102-1 is fully closed. As a more specific example, the threshold angular position may be 90 degrees, 80 degrees, 70 degrees, 60 degrees, 50 degrees, 40 degrees, 30 degrees, 20 degrees, 10 degrees, or any other value. In any case, the threshold angular position may indicate that the first tailgate door 102-1 is at an angular position where the second tailgate door 102-2 will not contact the first tailgate door 102-1 upon opening (i.e., that the first tailgate door 102-1 is not in a door path of the second tailgate door 102-2).

If the first tailgate door 102-1 is not more than the threshold amount open (block 703, determination NO), the tailgate control system 114 may prevent any door articulation as opening the second tailgate door 102-2 in this configuration with the first tailgate door 102-1 mostly closed, may cause the second tailgate door 102-2 to slam into the first tailgate door 102-1. That is, the first tailgate door 102-1 may be in the door path of the second tailgate door 102-2. If the first tailgate door 102-1 is more than the threshold amount open (block 703, determination YES), at 711, the tailgate control system 114 may open the second tailgate door (TD2) 102-2 by activating the second powered hinge 106-2.

Returning to 701, if the conditions are not met (block 701, determination NO), at 705, the tailgate control system 114 may determine whether the tailgate doors 102-1 and 102-2 are both in a closed state and whether the inter-door latch 112 is disengaged (e.g., based on latch states and/or door positions). Due to the sequential opening of the first tailgate door 102-1 and the second tailgate door 102-2, it may not be possible to open the second tailgate door 102-2 in an arrangement when both tailgate doors 102-1 and 102-2 are closed. Accordingly, in this example (block 705, determination YES), the tailgate control system 114 may refrain from activating any powered hinges 106.

If it’s not the case that both tailgate doors 102-1 and 102-2 are closed (block 705, determination NO), at 707 the tailgate control system 114 may determine whether the frame latches 108-1 and 108-2 are engaged and whether the first tailgate door 102-1 and the second tailgate door 102-2 are both in an open state. If both doors are in the open state (block 707, determination YES), at 709, the tailgate control system 114 determines if the first tailgate door 102-1 is more than a threshold amount open. As described above, this may involve determining whether the motor of the first powered hinge 106-1 has a step count higher than the step count that corresponds to a threshold rotational position of the first tailgate door 102-1. This threshold rotational position may be any amount, for example, between 0 and 180 degrees from a reference position, which reference position may be when the first tailgate door 102-1 is fully closed. As a more specific example, the threshold angular position may be 90 degrees, 80 degrees, 70 degrees, 60 degrees, 50 degrees, 40 degrees, 30 degrees, 20 degrees, 10 degrees, or any other value. In any case, the threshold angular position may indicate that the first tailgate door 102-1 is at an angular position where the second tailgate door 102-2 will not contact the first tailgate door 102-1 upon closing (i.e., that the first tailgate door 102-1 is not in a door path of the second tailgate door 102-2).

If the first tailgate door 102-1 is not more than the threshold amount open (block 709, determination NO), the tailgate control system 114 may prevent any door articulation, as closing the second tailgate door 102-2 in this configuration may cause the second tailgate door 102-2 to slam into the first tailgate door 102-1. That is, the first tailgate door 102-1 may be in the door path of the second tailgate door 102-2.

If the first tailgate door is more than the threshold amount open (709, determination YES), at 713, the tailgate control system 114 may close the second tailgate door 102-2, for example, by activating the second powered hinge 106-2.

Returning to 707, if the conditions are not met (block 707, determination NO), it may indicate that the second tailgate door 102-2 is in an open state and the first tailgate door 102-1 is in a closed state. Given the arrangement of the inter-door latch 112 on the first tailgate door 102-1 and the strike plate 240 on the second tailgate door 102-2, it may be that closing the second tailgate door 102-2 in this configuration may cause the strike plate 240 to slam against the first tailgate door 102-1 rather than being seated in the frame member 104. Accordingly, the tailgate control system 114 may block the second tailgate door 102-2 from closing in this configuration.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a machine-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more machine-readable media having machine-readable program code embodied, e.g., stored, thereon. Any combination of one or more machine-readable media may be utilized. The phrase “machine-readable storage medium” means a non-transitory storage medium. A machine-readable storage medium may be, for example, but not limited to, an electronic, magnetic, optical, electromagnetic, infrared, or semiconductor system, apparatus, or device, or any suitable combination of the foregoing. A non-exhaustive list of machine-readable storage mediums can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a machine-readable storage medium is, for example, a tangible medium that stores a program for use by or in connection with an instruction execution system, apparatus, or device.

Program code embodied on a machine-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of … and ….” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

In this description, in one arrangement, the compartments of the vehicle include a passenger compartment, an engine compartment, a cargo area, and the like. Among other things, in one arrangement, the vehicle includes seats, a dash assembly, an instrument panel, controls, and the like housed in the passenger compartment. Additionally, in some instances, the vehicle may include an engine, a motor, a transmission, and the like, as well as other powertrain components, such as wheels, housed in the engine compartment and elsewhere in the vehicle. The wheels support the remainder of the vehicle on the ground. One, some, or all of the wheels are powered by the remainder of the powertrain components to drive the vehicle along the ground.

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
sequentially pivot a first tailgate door and a second tailgate door of a split-door tailgate assembly about respective vertical axes responsive to a first input;
pivot the first tailgate door about a first vertical axis responsive to a second input;
disengage frame latches to facilitate a pivot of the first tailgate door and the second tailgate door about a horizontal axis responsive to a third input; and
pivot the second tailgate door about a second vertical axis responsive to a fourth input.

2. The system of claim 1, wherein:
the first input is a first input type from a first switch;
the second input is a second input type from the first switch;
the third input is an input from a second switch; and
the fourth input is an input from a third switch.

3. The system of claim 2, wherein:
the machine-readable instruction that causes the processor to sequentially pivot the first tailgate door and the second tailgate door about the respective vertical axes responsive to the first input comprises a machine-readable instruction that causes the processor to sequentially pivot the first tailgate door and the second tailgate door responsive to a long pulse from the first switch; and
the machine-readable instruction that causes the processor to pivot the first tailgate door about the first vertical axis responsive to the second input comprises a machine-readable instruction that causes the processor to pivot the first tailgate door responsive to a short pulse from the first switch.

4. The system of claim 1, wherein the machine-readable instruction that causes the processor to sequentially pivot the first tailgate door and the second tailgate door about the respective vertical axes comprises machine-readable instructions that cause the processor to:
sequentially open the first tailgate door and the second tailgate door responsive to the first tailgate door being in a closed state and the second tailgate door being in the closed state;
sequentially close the second tailgate door and the first tailgate door responsive to the first tailgate door being in an open state and the second tailgate door being in the open state; and
close the first tailgate door responsive to the first tailgate door being in the open state and the second tailgate door being in the closed state.

5. The system of claim 1, wherein the machine-readable instruction that causes the processor to pivot the first tailgate door about the first vertical axis comprises machine-readable instructions that cause the processor to:
open the first tailgate door responsive to the first tailgate door being in a closed state and the second tailgate door being in the closed state;
close the first tailgate door responsive to the first tailgate door being in an open state and the second tailgate door being in the closed state; and
open the first tailgate door responsive to the first tailgate door being in the closed state and the second tailgate door being in the open state.

6. The system of claim 1, wherein the machine-readable instruction that causes the processor to disengage the frame latches comprises a machine-readable instruction that causes the processor to disengage the frame latches of a frame member to which tailgate doors are mounted, responsive to:
the first tailgate door being in a closed state;
the second tailgate door being in the closed state; and
an inter-door latch being engaged.

7. The system of claim 1, wherein the memory further comprises a machine-readable instruction that causes the processor to, responsive to the third input, transmit a control signal to a powered tailgate hinge to lower the first tailgate door and the second tailgate door that are coupled together via an inter-door latch.

8. The system of claim 1, wherein the machine-readable instruction that causes the processor to pivot the second tailgate door about the second vertical axis comprises machine-readable instructions that cause the processor to:
open the second tailgate door responsive to the first tailgate door being in an open state and the second tailgate door being in a closed state; and
close the second tailgate door responsive to the first tailgate door being in the open state and the second tailgate door being in the open state.

9. The system of claim 1, wherein the memory further comprises machine-readable instructions that, when executed by the processor, cause the processor to determine a state of the first tailgate door and a state of the second tailgate door based on:
a first frame latch state;
a second frame latch state;
a first door latch state;
a second door latch state; and
an inter-door latch state.

10. The system of claim 1, wherein the memory further comprises machine-readable instructions that, when executed by the processor, cause the processor to determine:
a state of the first tailgate door based on a first tailgate door position; and
a state of the second tailgate door based on a second tailgate door position.

11. The system of claim 1, wherein the memory further comprises machine-readable instructions that, when executed by the processor, cause the processor to:
interrupt an articulation of a tailgate door based on at least one of:
an output of an environment sensor detecting an obstruction in a door path; or
an input at a switch that initiated the articulation; and
resume the articulation responsive to:
the obstruction clearing the door path; or
an input at the switch that initiated the articulation.

12. A non-transitory machine-readable medium comprising instructions that, when executed by a processor, cause the processor to:
sequentially pivot a first tailgate door and a second tailgate door of a split-door tailgate assembly about respective vertical axes responsive to a first input;
pivot the first tailgate door about a first vertical axis responsive to a second input;
disengage frame latches to facilitate a pivot of the first tailgate door and the second tailgate door about a horizontal axis responsive to a third input; and
pivot the second tailgate door about a second vertical axis responsive to a fourth input.

13. The non-transitory machine-readable medium of claim 12, wherein:
the first input is a first input type from a first switch;
the second input is a second input type from the first switch;
the third input is an input from a second switch; and
the fourth input is an input from a third switch.

14. The non-transitory machine-readable medium of claim 12, wherein:
the instruction that causes the processor to sequentially pivot the first tailgate door and the second tailgate door about the respective vertical axes comprises instructions that cause the processor to:
sequentially open the first tailgate door and the second tailgate door responsive to the first tailgate door being in a closed state and the second tailgate door being in the closed state;
sequentially close the second tailgate door and the first tailgate door responsive to the first tailgate door being in an open state and the second tailgate door being in the open state; and
close the first tailgate door responsive to the first tailgate door being in the open state and the second tailgate door being in the closed state; and
the instruction that causes the processor to pivot the first tailgate door about the first vertical axis comprises machine-readable instructions that cause the processor to:
open the first tailgate door responsive to the first tailgate door being in the closed state and the second tailgate door being in the closed state;
close the first tailgate door responsive to the first tailgate door being in the open state and the second tailgate door being in the closed state; and
open the first tailgate door responsive to the first tailgate door being in the closed state and the second tailgate door being in the open state.

15. The non-transitory machine-readable medium of claim 12, wherein the instruction that causes the processor to disengage the frame latche comprises machine-readable instructions that cause the processor to disengage the frame latches of a frame member to which tailgate doors are mounted, responsive to:
the first tailgate door being in a closed state;
the second tailgate door being in the closed state; and
an inter-door latch being engaged.

16. The non-transitory machine-readable medium of claim 12, wherein the instruction that causes the processor to pivot the second tailgate door about the second vertical axis comprises machine-readable instructions that cause the processor to:
open the second tailgate door responsive to the first tailgate door being in an open state and the second tailgate door being in a closed state; and
close the second tailgate door responsive to the first tailgate door being in the open state and the second tailgate door being in the open state.

17. A method, comprising:
sequentially pivoting a first tailgate door and a second tailgate door of a split-door tailgate assembly about respective vertical axes responsive to a first input;
pivoting the first tailgate door about a first vertical axis responsive to a second input;
disengaging frame latches to facilitate a pivot of the first tailgate door and the second tailgate door about a horizontal axis responsive to a third input; and
pivoting the second tailgate door about a second vertical axis responsive to a fourth input.

18. The method of claim 17, wherein:
the first input is a first input type from a first switch;
the second input is a second input type from the first switch;
the third input is an input from a second switch; and
the fourth input is an input from a third switch.

19. The method of claim 17, wherein:
sequentially pivoting the first tailgate door and the second tailgate door about the respective vertical axes comprises:
sequentially opening the first tailgate door and the second tailgate door responsive to the first tailgate door being in a closed state and the second tailgate door being in the closed state;
sequentially closing the second tailgate door and the first tailgate door responsive to the first tailgate door being in an open state and the second tailgate door being in the open state; and
closing the first tailgate door responsive to the first tailgate door being in the open state and the second tailgate door being in the closed state; and
pivoting the first tailgate door about the first vertical axis comprises:
opening the first tailgate door responsive to the first tailgate door being in the closed state and the second tailgate door being in the closed state;
closing the first tailgate door responsive to the first tailgate door being in the open state and the second tailgate door being in the closed state; and
opening the first tailgate door responsive to the first tailgate door being in the closed state and the second tailgate door being in the open state.

20. The method of claim 17, wherein pivoting the second tailgate door about the second vertical axis comprises:
opening the second tailgate door responsive to the first tailgate door being in an open state and the second tailgate door being in a closed state; and
closing the second tailgate door responsive to the first tailgate door being in the open state and the second tailgate door being in the open state.
